(19) United States
(12) Patent Application Publication
(10) Pub. No.: US 2009/0095422 A1
(43) Pub. Date: Apr. 16, 2009

(54) SEMICONDUCTOR MANUFACTURING APPARATUS AND SUBSTRATE PROCESSING METHOD

(75) Inventors: Masashi SUGISHITA, Toyama-shi (JP); Masaaki Ueno, Toyama-shi (JP); Akira Hayashida, Toyama-shi (JP)

Correspondence Address: MATTINGLY, STANGER, MALUR & BRUNDIDGE, P.C., 1800 DIAGONAL ROAD, SUITE 370, ALEXANDRIA, VA, 22314, US

(73) Assignee: Hitachi Kokusai Electric Inc.

(21) Appl. No.: 12/205,075

(22) Filed: Sep. 5, 2008

(30) Foreign Application Priority Data
Sep. 6, 2007 (JP) 2007-231253
Jun. 30, 2008 (JP) 2008-170810

(51) Int. Cl. C23F 1/00; B05C 11/00

(52) U.S. Cl. 156/345.27; 118/708

(57) ABSTRACT

Provided are a semiconductor manufacturing apparatus and a substrate processing method that can reduce a temperature difference along the circumference of a substrate and continue substrate processing even when a temperature sensor becomes defective. The semiconductor manufacturing apparatus includes a reaction tube configured to process a wafer, a heater configured to heat the reaction tube, an exhaust pipe, a control unit configured to control a cooling gas exhaust device, the heater, and a pressure sensor that detects a pressure inside the exhaust pipe when cooling gas flows through the exhaust pipe. The control unit previously acquires an average value of second temperature detecting units that detect states of a peripheral part of a wafer, and a measure value of a first temperature detecting unit that detects a state of a center part of the wafer so as to control the heat and the cooling device based on the acquired values.

### CROSS-REFERENCE TO RELATED PATENT APPLICATION

This U.S. non-provisional patent application claims priority under 35 U.S.C. § 119 of Japanese Patent Application Nos. 2007-231253, filed on Sep. 6, 2007, and 2008-170810, filed on Jun. 30, 2008, in the Japanese Patent Office, the entire contents of which are hereby incorporated by reference.

### BACKGROUND OF THE INVENTION

1. Field of the Invention

The present invention relates to a substrate processing method and a semiconductor manufacturing apparatus for processing a substrate such as a semiconductor wafer, and more particularly, to a substrate processing apparatus and a semiconductor manufacturing apparatus having a plurality of thermocouples used in heat treatment for measuring temperatures at positions near a substrate, the thermocouples being installed along the circumference of the substrate for using control values detected by the thermocouples in reducing a temperature difference along the circumference of the substrate.

In addition, the substrate processing apparatus and the semiconductor manufacturing apparatus use correction values for the thermocouples so that even when one of the thermocouples malfunctions, a temperature that may be detected from the malfunctioning thermocouple can be predicted using the correction value of the malfunctioning thermocouple, and thus temperature control can be continued.

2. Description of the Prior Art

For example, in a substrate processing apparatus disclosed in Patent Document 1, a temperature difference between end and center parts of a substrate which is caused by changing the heating temperature of the substrate within a certain interval, and a steady-state temperature difference between the end and center parts of the substrate are used to calculate a temperature variation amount N resulting in a desired average temperature deviation M, so that the heating temperature of the substrate can be controlled for forming a film on the substrate uniformly.

However, although the desired average temperature deviation M is attained, there is a limitation on the thickness uniformity of a film formed on the substrate.

Furthermore, in a known technology for controlling the temperature of a semiconductor manufacturing apparatus, a plurality of temperature sensors (temperature detecting units or thermocouples) are installed in a furnace made of a material such as quartz and having a shape such as an elongated cylindrical shape to detect temperatures inside the furnace, and the furnace is controlled based on the detected temperatures using a temperature control device to keep the inside of the furnace, for example, at a temperature indicated by an upper-level controller.

In a semiconductor manufacturing apparatus, because of various reasons such as heater installation errors causing an improper distance between a heater element and a furnace, installation errors of quartz members such as a so-called inner tube and an outer tube of the semiconductor manufacturing apparatus, and variations of temperature caused by a supporting post of a so-called boat, a temperature difference can occur along the circumference of a substrate inside a furnace. Thus, a mechanism configured to rotate the boat has been introduced as technology for reducing such a temperature difference.

However, in such a semiconductor manufacturing apparatus, the temperature difference along the circumference of the substrate is not reduced in the case where a temperature can be measured only at a part of the circumference of a substrate.

Furthermore, in a conventional semiconductor manufacturing apparatus, it is difficult to control the temperature of a substrate when one of a plurality of temperature sensors is defective, and in this case, the film quality of the substrate can be degraded. Moreover, since the operating rate of the apparatus decreases, there is a problem in that substrate processing is undesirably stopped.

Furthermore, in a conventional semiconductor manufacturing apparatus, if one of a plurality of thermocouples is defective, it is difficult to control the temperature of a substrate, and the film quality of the substrate can be degraded. Moreover, since the operating rate of the apparatus decreases, there is a problem in that substrate processing can be undesirably stopped.

[Patent Document 1] International Publication No. 2005/008755 Pamphlet.

### SUMMARY OF THE INVENTION

An object of the present invention is to provide a semiconductor manufacturing apparatus and a substrate processing method that can reduce a temperature difference along the circumference of a substrate and continue substrate processing even when a temperature sensor malfunctions.

According to an aspect of the present invention, there is provided a semiconductor manufacturing apparatus including: a processing chamber configured to process a substrate; a heating device configured to heat the processing chamber; a cooling gas passage between the processing chamber and the heating device; a pressure detector configured to measure a pressure value at the cooling gas passage; a temperature detecting unit configured to detect a temperature of the substrate; and a control unit configured to control the heating device and a cooling device for processing the substrate, wherein the control unit previously acquires a measured value of a first temperature detecting unit that detects a temperature of a center part of the substrate, and an average value of measured values of a plurality of detecting points arranged along a circumference of the substrate and provided in a second temperature detecting unit that detects temperatures of a peripheral part of the substrate, and the control unit controls the heating device and the cooling device based on the acquired values.

According to another aspect of the present invention, there is provided a substrate processing method including: a step of previously acquiring a measured value of a first temperature detecting unit that detects a temperature of a center part of a substrate, and an average value of measured values of a plurality of detecting points arranged along a circumference of the substrate and provided in a second temperature detecting unit that detects temperatures of a peripheral part of the substrate, calculating a pressure correction value for a pressure value of a cooling gas passage formed between a processing chamber configured to process the substrate and a heating device based on the acquired values, and correcting the pressure value using the pressure correction value; and a step of supplying a cooling gas through the cooling gas passage using a cooling device, while heating the processing chamber using the heating device, and controlling the heating device and the cooling device using a control unit based on the corrected pressure value, so as to process the substrate.

According to another aspect of the present invention, there is provided a semiconductor manufacturing apparatus including: a processing chamber configured to process a substrate; a heating device configured to heat the processing chamber; a cooling gas passage between the processing chamber and the heating device; a pressure detector configured to measure a pressure value at the cooling gas passage; a plurality of temperature detecting units configured to detect temperatures inside the processing chamber; and a control unit configured to control the heating device and a cooling device for processing the substrate, wherein the control unit calculates an average value of measured values of the temperature detecting units that detect temperatures inside the processing chamber, and deviations of the measured values of the temperature detecting units from the average value of the measured values, and the control unit controls at least one of the heating device and the cooling device based on the calculated deviations.

According to another aspect of the present invention, there is provided a substrate processing method including: a step of previously acquiring an average value of measured values of a plurality of detecting points arranged along a circumference of a substrate and provided in a temperature detecting unit that detects temperatures of a peripheral part of the substrate, and a measured value of each of the detecting points, and calculating a pressure correction value for a pressure value of a cooling gas passage formed between a processing chamber configured to process the substrate and a heating device based on the acquired average value of the measured values of the detecting points and the measured value of each of the detecting points, so as to correct the pressure value using the pressure correction value; and a step of supplying a cooling gas through the cooling gas passage using a cooling device, while heating the processing chamber using the heating device, and controlling at least one of the heating device and the cooling device using a control unit based on the corrected pressure value, so as to process the substrate.

According to another aspect of the present invention, there is provided a semiconductor manufacturing apparatus including: a processing chamber configured to process a substrate; a heating device configured to heat the processing chamber; a cooling gas passage between the processing chamber and the heating device; a pressure detector configured to measure a pressure value at the cooling gas passage; a plurality of temperature detecting units configured to detect temperatures inside the processing chamber; and a control unit configured to control the heating device and a cooling device for processing the substrate, wherein the control unit calculates a deviation of a measured value of one of the temperature detecting units from an average value of measured values of the other temperature detecting units, and the control unit controls at least one of the heating device and the cooling device based on the calculated deviation.

According to another aspect of the present invention, there is provided a substrate processing method including: a step of previously acquiring a measured value of one of a plurality of detecting points arranged along a circumference of a substrate and provided in a temperature detecting unit that detects temperatures of a peripheral part of the substrate, and an average value of measured values of the other detecting points, and calculating a pressure correction value for a pressure value of a cooling gas passage formed between a processing chamber configured to process the substrate and a heating device based on the acquired average value of the measured values of the other detecting points and the measured value of one of the detecting points, so as to correct the pressure value using the pressure correction value; and a step of supplying a cooling gas through the cooling gas passage using a cooling device, while heating the processing chamber using the heating device, and controlling at least one of the heating device and the cooling device using a control unit based on the corrected pressure value, so as to process the substrate.

### BRIEF DESCRIPTION OF THE DRAWINGS

FIG. 1 is a schematic view illustrating a substrate processing apparatus relevant to a first type to which the present invention is applied.

FIG. 2 is a schematic view illustrating a reaction tube included in the substrate processing apparatus relevant to the first type to which the present invention is applied.

FIG. 3 illustrates an exemplary detailed structure of a center thermocouple included in the substrate processing apparatus relevant to the first type to which the present invention is applied.

FIG. 4 illustrates an exemplary detailed structure of a ceiling thermocouple included in the substrate processing apparatus relevant to the first type to which the present invention is applied.

FIG. 5 illustrates an exemplary detailed structure of a lower thermocouple included in the substrate processing apparatus relevant to the first type to which the present invention is applied.

FIG. 6 is a schematic view illustrating a semiconductor manufacturing apparatus relevant to the first type to which the present invention is applied.

FIG. 7 is a view illustrating a semiconductor manufacturing apparatus relevant to the first type to which the present invention is applied, to explain a structure and method for correcting a set temperature using a temperature correction value of a center part of a wafer.

FIG. 8 illustrates a table containing data on center part temperature deviations and ceiling part temperature deviations acquired by a semiconductor manufacturing apparatus relevant to the first type to which the present invention is applied.

FIG. 9 is a first view for explaining how a pressure correction value is calculated in a semiconductor manufacturing apparatus relevant to the first type to which the present invention is applied.

FIG. 10 is a second view for explaining how a pressure correction value is calculated in a semiconductor manufacturing apparatus relevant to the first type to which the present invention is applied.

FIG. 11 is a perspective view illustrating a main part of a semiconductor manufacturing apparatus relevant to a first embodiment of the present invention.

FIG. 12 is a schematic view illustrating planar arrangement of thermocouples included in the semiconductor manufacturing apparatus relevant to the first embodiment of the present invention.

FIG. 13 is a view for explaining a control method and configuration for the semiconductor manufacturing apparatus relevant to the first embodiment of the present invention.

FIG. 14 is a view for explaining a control method and configuration for a semiconductor manufacturing apparatus relevant to a second embodiment of the present invention.

FIG. 15 is a view illustrating the overall structure of a semiconductor processing apparatus relevant to a second type to which the present invention is applied.

FIG. 16 illustrates a processing chamber depicted in FIG. 15, in which a boat and wafers are accommodated.

FIG. 17 illustrates nearby parts of the processing chamber depicted in FIG. 15 and FIG. 16, and a structure of a first control program used to control the processing chamber.

FIG. 18 illustrates the configuration of a control unit depicted in FIG. 15.

FIG. 19 illustrates an exemplary shape of a wafer that is a processing object of a semiconductor processing apparatus relevant to the second type to which the present invention is applied.

FIG. 20 illustrates the structure of a semiconductor processing apparatus relevant to a third type to which the present invention is applied.

FIG. 21 illustrates the structure of a semiconductor processing apparatus relevant to a fourth type to which the present invention is applied.

FIG. 22 is an exemplary view for explaining a calculation operation of a pressure set value in a semiconductor processing apparatus relevant to a fourth embodiment of the present invention.

FIG. 23 is a view illustrating a relationship between a current set temperature and a predicted temperature.

FIG. 24 is a view illustrating a relationship between a current set temperature and a predicted temperature.

FIG. 25 is a view illustrating a relationship between a current set temperature and temperatures of inner temperature sensors predicted according to embodiments of the present invention.

FIG. 26 is a view illustrating a relationship between a current set temperature and average values of inner temperature sensors obtained according to embodiments of the present invention.

FIG. 27 is a view illustrating a relationship between a set temperature and a correction value with respect to time.

### DETAILED DESCRIPTION OF THE PREFERRED EMBODIMENTS

Embodiments of the present invention will be described hereinafter with reference to the attached drawings.

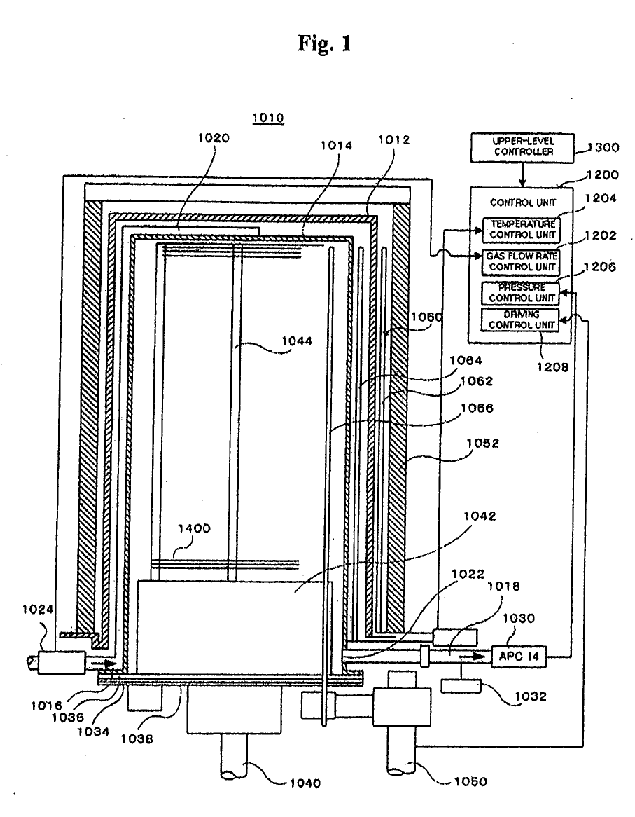

FIG. 1 to FIG. 7 show a semiconductor manufacturing apparatus 1010 relevant to a first type to which the present invention is applied.

As shown in FIG. 1, the semiconductor manufacturing apparatus 1010 includes a uniform heat pipe 1012 that is made of, for example, a heat-resistant material such as SiC and has a cylindrical shape with a closed top and an opened bottom. At the inside of the uniform heat pipe 1012, a reaction tube 1014 used as a reaction vessel is installed. The reaction tube 1014 is made of, for example, a heat-resistant material such as quartz (SiO₂), formed into a cylindrical shape with an opened bottom and disposed inside the uniform heat pipe 1012 coaxially.

To the bottom of the reaction tube 1014, a gas supply pipe 1016 made of a material such as quartz, and an exhaust pipe 1018 are connected. At the supply pipe 1016, an introducing member 1020 having a gas introducing hole is installed, and the gas supply pipe 1016 and the introducing member 1020 extend from the bottom of the reaction tube 1014 along a side part of the reaction tube 1014, for example, with a slender pipe shape and reach the inside of the reaction tube 1014 at a ceiling part of the reaction tube 1014.

The exhaust pipe 1018 is connected to an exhaust hole 1022 formed in the reaction tube 1014.

The gas supply pipe 1016 allows a flow of gas from the ceiling part of the reaction tube 1014 to the inside of the reaction tube 1014, and the exhaust pipe 1018 connected to the bottom of the reaction tube 1014 is used for exhaustion from the bottom of the reaction tube 1014. The reaction tube 1014 is configured so that a processing gas is supplied to the reaction tube 1014 through the gas supply pipe 1016 and the introducing member 1020. In addition, a mass flow controller (MFC) 1024, used as a flow rate control unit for controlling the flow rate of gas, or a water-vapor generator (not shown) is connected to the gas supply pipe 1016. The MFC 1024 is connected to a gas flow rate control unit 1202 (gas flow rate control device) provided in a control unit 1200 (control device), and the gas flow rate control unit 1202 controls the flow rate of supply gas or water vapor (H₂O), for example, at a predetermined level.

The control unit 1200 includes the above-described gas flow rate control unit 1202, a temperature control unit 1204 (temperature control device), a pressure control unit 1206 (pressure control device), and a driving control unit 1208 (driving control device). The control unit 1200 is connected to an upper-level controller 1300 and controlled by the upper-level controller 1300.

At the exhaust pipe 1018, an auto pressure control (APC) 1030 used as a pressure regulating unit, and a pressure sensor 1032 used as a pressure detecting unit are installed. Based on pressure information detected by the pressure sensor 1032, the APC 1030 controls the amount of gas discharged from the reaction tube 1014 and the pressure inside the reaction tube 1014, for example, at a constant level.

At an opening formed in the bottom of the reaction tube 1014, a base 1034, which is formed of a material such as quartz, for example, into a disk shape and used as a holder, is attached with an O-ring 1036 in-between. The base 1034 can be attached to and detached from the reaction tube 1014, and when attached to the reaction tube 1014, the base 1034 seals the reaction tube 1014. For example, the base 1034 is attached to the upper surface of an approximately disk shaped seal cap 1038 in a gravitational direction.

A rotation shaft 1040 used as a rotation unit is connected to the seal cap 1038. The rotation shaft 1040 is rotated by power from a driving unit (not shown) to rotate a quartz cap 1042 used as a holder, a boat 1044 used as a substrate holding member, and wafers 1400 held in the boat 1044 as substrates. The rotation speed of the rotation shaft 1040 is controlled by the above-described control unit 1200.

In addition, the semiconductor manufacturing apparatus 1010 includes a boat elevator 1050 which is used to move the boat 1044 upward and downward and controlled by the above-described control unit 1200.

Around the circumference of the reaction tube 1014, a heater 1052 used as a heating unit is disposed coaxially. To keep the inside of the reaction tube 1014 at a processing temperature which is set by the upper-level controller 1300, the heater 1052 is controlled by the temperature control unit 1204 based on a temperature detected by a temperature detecting unit 1060 (temperature detecting device) which is provided with a first thermocouple 1062, a second thermocouple 1064, and a third thermocouple 1066.

The first thermocouple 1062 is used to detect a temperature of the heater 1052, and the second thermocouple 1064 is used to detect a temperature between the uniform heat pipe 1012 and the reaction tube 1014. Alternatively, the second thermocouple 1064 may be installed between the reaction tube 1014 and the boat 1044 for detecting a temperature inside the reaction tube 1014. The third thermocouple 1066 is installed between the reaction tube 1014 and the boat 1044 at a position closer to the boat 1044 than the second thermocouple 1064 is, in order to detect a temperature at a position closer to the boat 1044. In addition, the third thermocouple 1066 is used to measure temperature uniformity inside the reaction tube 1014 during a stable temperature period.

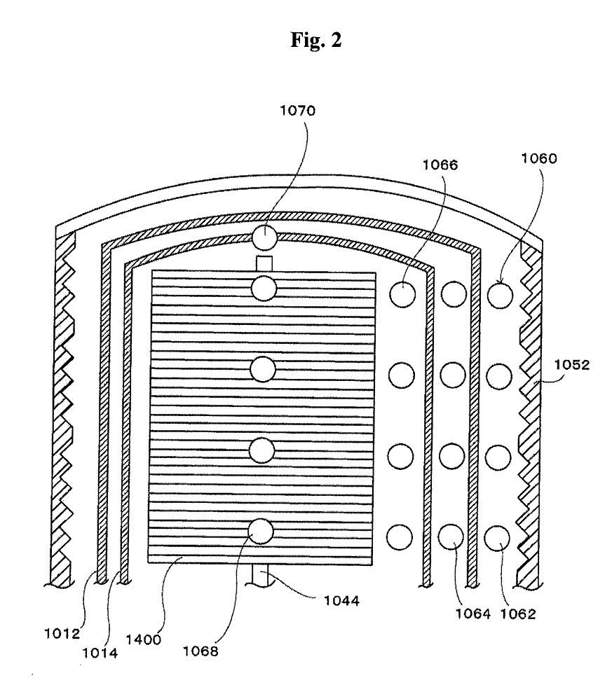

FIG. 2 illustrates nearby parts of the reaction tube 1014 schematically.

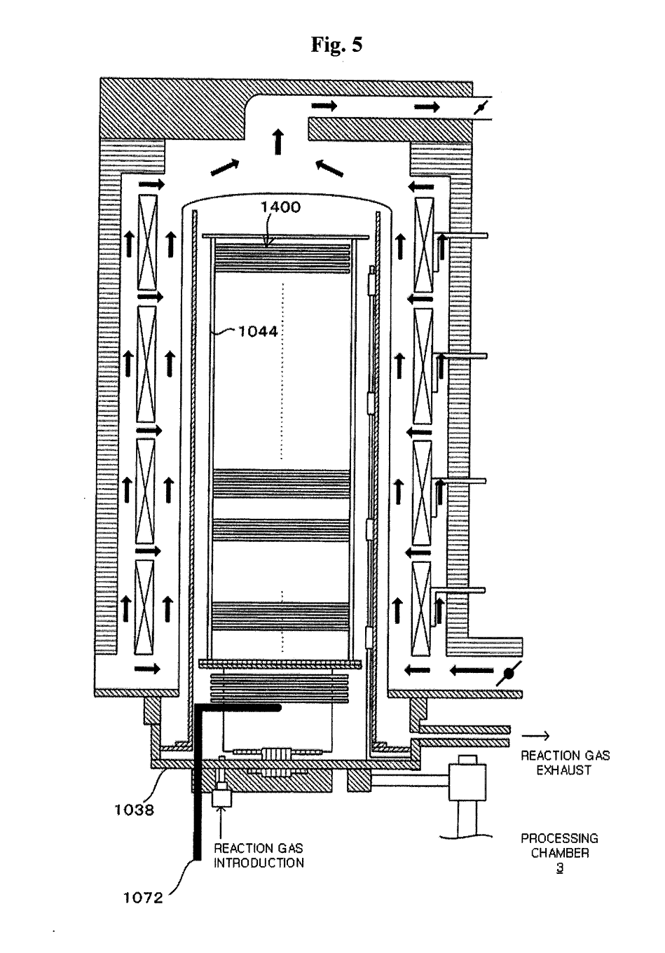

As described above, the semiconductor manufacturing apparatus 1010 includes the temperature detecting unit 1060, which is provided with the first thermocouple 1062, the second thermocouple 1064, and the third thermocouple 1066. As shown in FIG. 2, the temperature detecting unit 1060 includes a center thermocouple 1068 for detecting temperatures at nearly the center parts of the wafers 1400, and a ceiling thermocouple 1070 for detecting a temperature at the vicinity of a ceiling part of the boat 1044. In addition, a lower thermocouple 1072 (described later in FIG. 5) may be installed at the semiconductor manufacturing apparatus 1010.

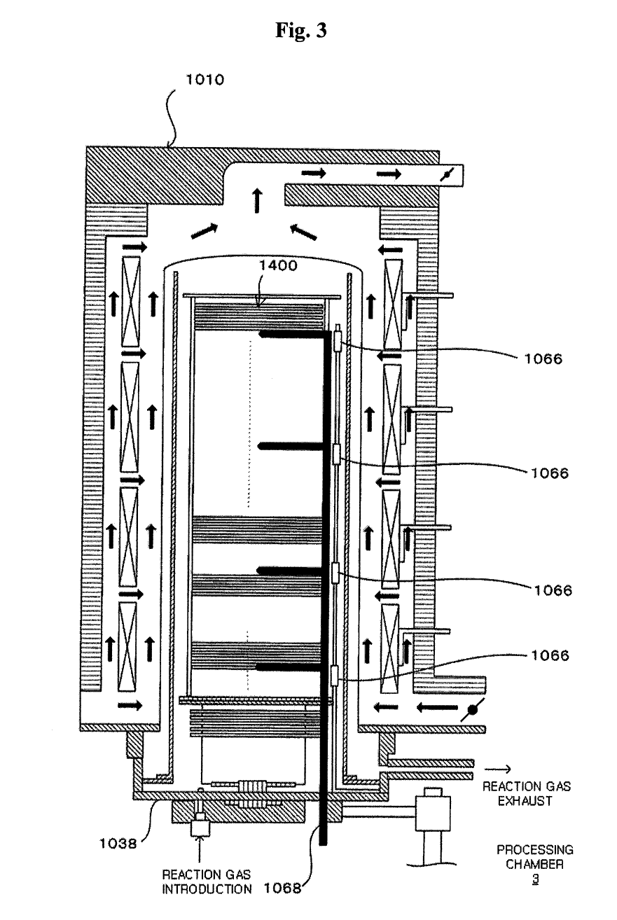

FIG. 3 illustrates an exemplary detailed structure of the center thermocouple 1068.

As shown in FIG. 3, the center thermocouple 1068 is formed into, for example, an L-shape covering a plurality of positions for measuring temperatures at a plurality of positions near the centers of the wafers 1400 at substantially the same heights as the third thermocouple 1066, and the center thermocouple 1068 outputs measured temperatures. The center thermocouple 1068 is configured to measure temperatures at a plurality of positions near the centers of the wafers 1400 before the semiconductor manufacturing apparatus 1010 starts to process the wafers 1400, and configured to be detached when the semiconductor manufacturing apparatus 1010 processes the wafers 1400.

The center thermocouple 1068 is configured to be detached from the reaction tube 1014 so that when the boat 1044 is rotated or wafers 1400 are charged into the boat 1044, the center thermocouple 1068 can be detached to prevent contact with other members. In addition, the center thermocouple 1068 is configured to be sealed at the seal cap 1038 with a joint member in-between.

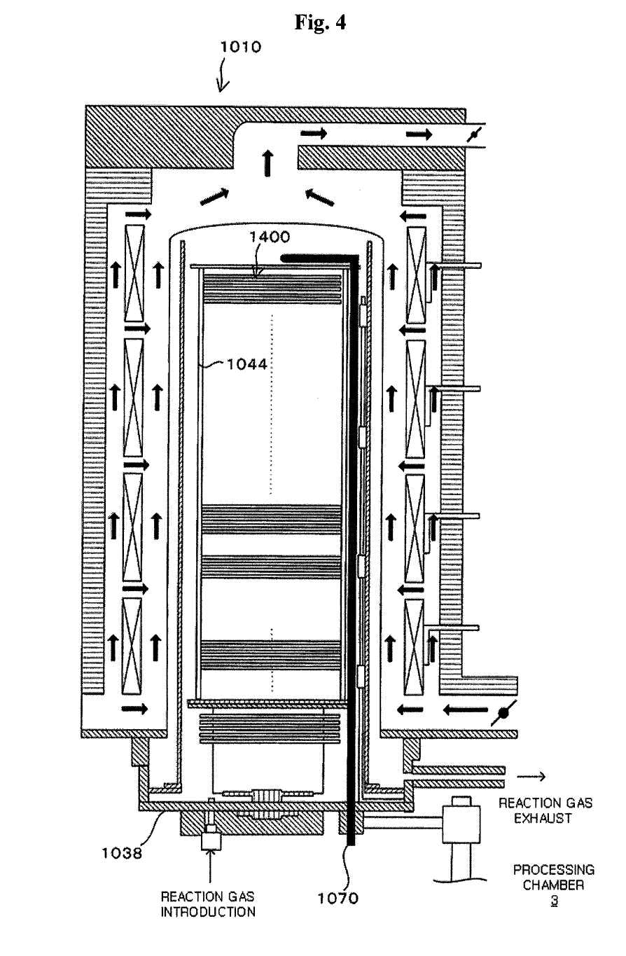

FIG. 4 illustrates an exemplary detailed structure of the ceiling thermocouple 1070.

As shown in FIG. 4, the ceiling thermocouple 1070 has an L-shape and is installed above a ceiling plate of the boat 1044 for measuring a temperature at a position near the ceiling part of the boat 1044 and outputting the measured temperature. Unlike the center thermocouple 1068, the ceiling thermocouple 1070 is installed above the ceiling plate of the boat 1044. Therefore, loading or unloading, and rotation of the boat 1044 are possible, and thus even when the semiconductor manufacturing apparatus 1010 processes the wafers 1400, the ceiling thermocouple 1070 can be used in an installed state for measuring a temperature at a position near the ceiling part of the boat 1044. Like the center thermocouple 1068, the ceiling thermocouple 1070 is configured to be sealed at the seal cap 1038 with a joint member in-between.

FIG. 5 illustrates an exemplary detailed structure of the lower thermocouple 1072.

As shown in FIG. 5, the lower thermocouple 1072 has an L-shape and is installed at the downside of the boat 1044 between insulating plates to measure a temperature at a position near the downside of the boat 1044 and output the measured temperature. Instead of installing the lower thermocouple 1072 between mutually neighboring upper and lower plates of the plurality of insulating plates installed at the downside of the boat 1044, the lower thermocouple 1072 may be installed at the upside of the uppermost insulating plate of the plurality of insulating plates or at the downside of the lowermost insulating plate of the plurality of insulating plates.

Since the lower thermocouple 1072 is loaded and unloaded together with the boat 1044, the lower thermocouple 1072 can be used in an installed state for measuring a temperature at a position near the downside of the boat 1044 even when the semiconductor manufacturing apparatus 1010 processes the wafers 1400. The lower thermocouple 1072 is configured to be sealed at the seal cap 1038 with a joint member in-between.

In the above-described semiconductor manufacturing apparatus 1010, an exemplary operation for processing the wafers 1400 in the reaction tube 1014 by oxidation or diffusion will be described hereinafter (refer to FIG. 1).

First, the boat 1044 is moved downward by the boat elevator 1050. Next, a plurality of wafers 1400 are held in the boat 1044. Then, the heater 1052 is operated to increase the temperature inside the reaction tube 1014 to a predetermined processing temperature.

Then, the reaction tube 1014 is previously filled with inert gas using the MFC 1024 connected to the gas supply pipe 1016, and the boat 1044 is moved upward into the reaction tube 1014 using the boat elevator 1050 to maintain the temperature inside the reaction tube 1014 at the predetermined processing temperature. After the pressure inside the reaction tube 1014 is maintained at a predetermined level, the boat 1044 and the wafers 1400 held in the boat 1044 are rotated by using the rotation shaft 1040. At the same time, a processing gas is supplied through the gas supply pipe 1016, or water vapor is supplied from the water-vapor generator (not shown). The supplied gas descends the reaction tube 1014 and is uniformly supplied to the wafers 1400.

During an oxidation-diffusion process, the inside of the reaction tube 1014 is exhausted through the exhaust pipe 1018, and the pressure inside the reaction tube 1014 is controlled by the APC 1030 to a predetermined level, so as to process the wafers 1400 by oxidation-diffusion for a predetermined time. After the oxidation-diffusion process, to perform the oxidation-diffusion process on the next wafers 1400 among wafers 1400 to be successively processed, the gas inside the reaction tube 1014 is replaced with inert gas, and at the time, the pressure inside the reaction tube 1014 is adjusted to atmospheric pressure. Then, the boat 1044 is moved downward using the boat elevator 1050 to take the boat 1044 and the processed wafers 1400 out of the reaction tube 1014.

The processed wafers 1400 of the boat 1044 taken out of the reaction tube 1014 are replaced with non-processed wafers 1400, and then the boat 1044 is moved upward into the reaction tube 1014 so that the oxidation-diffusion process can be performed on the next wafers 1400.

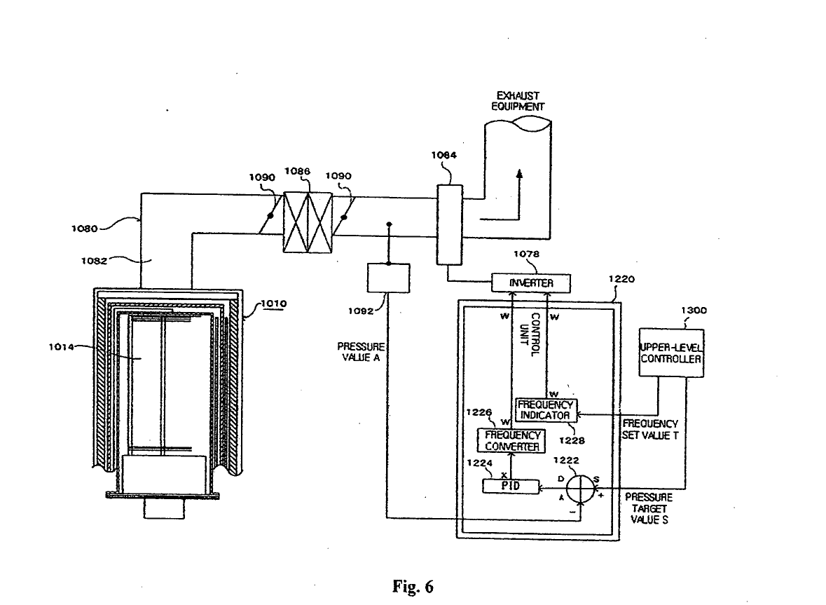

FIG. 6 is a schematic view illustrating structures provided for the semiconductor manufacturing apparatus 1010 relevant to the first type to which the present invention is applied, in addition to the structures illustrated in FIG. 1 to FIG. 5. Owing to the illustrated structures, unevenness in the thickness of a thin film formed on a processed wafer 1400 can be suppressed, and the thickness of the thin film can be uniformly maintained.

As shown in FIG. 6, the semiconductor manufacturing apparatus 1010 is provided with an exhaust pipe 1083 and includes an exhausting unit 1080 (exhaust device) for exhausting cooling gas. The exhaust pipe 1082 is used as a cooling gas exhaust passage, and a base end side thereof is connected to the reaction tube 1014, for example, to an upper part of the reaction tube 1014 and a leading end side thereof is connected to exhaust equipment of, for example, a plant at which the semiconductor manufacturing apparatus 1010 is installed, so that cooling gas can be exhausted through the exhaust pipe 1082.

In addition, the exhausting unit 1080 includes a cooling gas exhaust device 1084 configured by a blower or the like, and a radiator 1086. The cooling gas exhaust device 1084 is attached to a leading end side of the exhaust pipe 1082, and the radiator 1086 is mounted between a base end side of the exhaust pipe 1082 and the cooling gas exhaust device 1084. An inverter 1078 is connected to the cooling gas exhaust device 1084 to control the flow rate of gas exhausted by the cooling gas exhaust device 1084, for example, by controlling the speed of the blower.

Along a cooling gas flow direction of the radiator 1086 of the exhaust pipe 1082, shutters 1090 are installed at upstream and downstream sides, respectively. The shutters 1090 are closed and opened under the control of a shutter control unit (shutter control device, not shown).

At a position of the exhaust pipe 1082 between the radiator 1086 and the cooling gas exhaust device 1084, a pressure sensor 1092 is installed as a detecting unit (detecting device) for detecting the pressure inside the exhaust pipe 1082. Here, as a position at which the pressure sensor 1092 is installed, a position as close as possible to the radiator 1086 is preferable among positions of a part of the exhaust pipe 1082 connecting the cooling gas exhaust device 1084 and the radiator 1086.

As described in FIG. 1, the control unit 1200 (control device) includes the gas flow rate control unit 1202 (gas flow rate control device), the temperature control unit 1204 (temperature control device), the pressure control unit 1206 (pressure control device), and the driving control unit 1208 (driving control device). In addition, as shown in FIG. 6, the control unit 1200 further includes a cooling gas flow rate control unit 1220 (cooling gas control device).

The cooling gas flow rate control unit 1220 is configured by a subtracter 1222, a proportional integral derivative (PID) calculating unit 1224, a frequency converter 1226, and a frequency indicator 1228.

The subtracter 1222 receives a pressure target value (S) from the upper-level controller 1300. In addition to the pressure target value (S), the subtracter 1222 receives a pressure value (A) measured by the pressure sensor 1092, and outputs a deviation (D) calculated by subtracting the pressure value (A) from the pressure target value (S).

The deviation (D) is input to the PID calculating unit 1224. The PID calculating unit 1224 calculates an adjusting value (X) by PID operation based on the input deviation (D). The calculated adjusting value (X) is input to the frequency converter 1226, and the frequency converter 1226 outputs a frequency (W) by converting the adjusting value (X). The output frequency (W) is input to the inverter 1078 to change the frequency of the cooling gas exhaust device 1084.

The pressure value (A) is input to the subtracter 1222 from the pressure sensor 1092 at all times or at predetermined intervals, and based on the pressure value (A), the frequency of the cooling gas exhaust device 1084 is continuously controlled to maintain the deviation (D) of the pressure value (A) from the pressure target value (S) at a zero level.

Instead of calculating a frequency (W) using the PID calculating unit 1224, the upper-level controller 1300 may input a frequency set value (T) to the frequency indicator 1228, and the frequency indicator 1228 may input a frequency (W) to the inverter 1078, in order to change the frequency of the cooling gas exhaust device 1084.

As explained above, in the semiconductor manufacturing apparatus 1010, a cooling mechanism, in which the cooling gas exhaust device 1084 is used to supply air as a cooling medium between the inside of the heater 1052 and the reaction tube 1014, is used to cool a heating element constituting the heater 1052 or the reaction tube 1014 for temperature controlling. Therefore, the temperature of the wafers 1400 held in the reaction tube 1014 can be properly controlled.

That is, there are radiation heat transfer and convection heat transfer: in the semiconductor manufacturing apparatus 1010, heat is transferred to the wafers 1400 only by radiation to increase the temperature of the wafers 1400, and heat is dissipated by convection through air flowing between the inside of the heater 1052 and the reaction tube 1014. Therefore, to make up for heat dissipated by air from the vicinity of the heating element of the heater 1052, the output power of the heater 1052 is increased. Then, owing to the increase of the output power of the heater 1052, the temperature of the heating element of the heater 1052 increases, and radiant heat increases. Heat transfer by radiation is faster than heat transfer by convection. Therefore, the semiconductor manufacturing apparatus 1010, in which wafers are heated by radiation in the reaction tube 1014, can have good temperature controlling characteristics.

Furthermore, the temperature of the reaction tube 1014 decreases owing to cooling by air. Thus, when the temperature of the reaction tube 1014 decreases, heat is transferred from the edge part of the wafer 1400 to the reaction tube 1014. As a result, in the temperature distribution of the wafer 1400, the temperature of the edge part of the wafer 1400 becomes lower than that of the center part of the wafer 1400, and thus the temperature distribution of the wafer 1400 may change from a concave shape, in which the temperature of the edge part is higher than the center part, to a convex shape, in which the temperature of the edge part is lower than the temperature of the center part.

For example, when the temperature distribution of the wafer 1400 is uniform, the thickness of a thin film formed on the wafer 1400 varies in a concave shape in which the edge part of the thin film is thicker than the center part of the thin film. Therefore, by enabling the wafer 1400 to have a convex temperature distribution through the above-described temperature control, the uniformity of the film thickness of the wafer 1400 can be improved.

Furthermore, in the semiconductor manufacturing apparatus 1010, as explained above, the end side of the exhaust pipe 1082 is connected to the exhaust equipment of, for example, a plant at which the semiconductor manufacturing apparatus 1010 is installed to exhaust cooling gas from the reaction tube 1014 through the exhaust pipe 1082, and thus, the cooling effect by the cooling gas exhaust device 1084 may vary largely depending on the exhaust pressure of the exhaust equipment. Therefore, since the temperature distribution on the surface of the wafer 1400 is influenced if the cooling effect by the cooling gas exhaust device 1084 is varied, the frequency of the cooling gas exhaust device 1084 is controlled to maintain the exhaust pressure inside the exhaust pipe 1082 at a constant level.

Furthermore, in the semiconductor manufacturing apparatus 1010, for example, when a maintenance operation is performed, for example, for replacing a thermocouple such as the first thermocouple 1062, due to an attachment position error of the first thermocouple 1062, the thickness of a thin film of a wafer 1400 may be varied before and after maintenance. Moreover, if there are a plurality of semiconductor manufacturing apparatuses 1010 of the same specifications, thin films formed by the respective semiconductor manufacturing apparatuses 1010 may have different thicknesses.

Therefore, much study is conducted on the semiconductor manufacturing apparatus 1010 to improve the uniformity of a thin film, for example, before and after a maintenance operation, or in the case where a plurality of semiconductor manufacturing apparatuses 1010 of the same specifications are used.

In the semiconductor manufacturing apparatus 1010, while the temperature of the wafer 1400 is controlled to a predetermined level based on an output from the second thermocouple 1064, the temperature of the center part of the wafer 1400 is acquired from the center thermocouple 1068, and the temperature of the ceiling part of the boat 1044 is acquired from the ceiling thermocouple 1070. Then, for example, after a maintenance operation, a correction value for a pressure set value is calculated using the acquired data. This will be described hereinafter in detail.

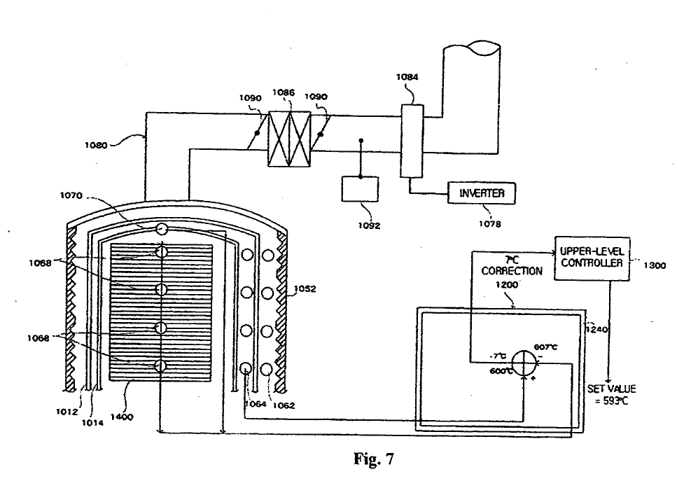

FIG. 7 is a view for explaining a structure and method for correcting a set temperature using a center part temperature correction value of a wafer 1400. The above-described control unit 1200 includes a wafer center part temperature correction calculating unit 1240 (wafer center part temperature correction calculating device).

In the following description, it is assumed that a temperature measured by the second thermocouple 1064 is 600° C. The wafer center part temperature correction calculating unit 1240 acquires an output value (wafer center part temperature) of the center thermocouple 1068 and an output value (ceiling part temperature) of the ceiling thermocouple 1070 when a control operation is performed using the second thermocouple 1064, and stores deviations of the acquired output values from the output value (inner temperature) of the second thermocouple 1064.

Here, the wafer center part temperature correction calculating unit 1240 stores the deviations as follows:

inner temperature−wafer center part temperature=wafer center part temperature deviation, or

inner temperature−ceiling part temperature=ceiling part temperature deviation.

In addition, a pressure set value (pressure difference from atmospheric pressure) at that time is also stored. The wafer center part temperature correction calculating unit 1240 acquires the data under a plurality of conditions by varying a pressure set value but not varying a set temperature.

In an exemplary case where the set temperature is 600° C., the inner temperature is 600° C., and the wafer center part temperature is 607° C., the inner temperature can be regarded as the temperature of the edge part of the wafer 1400. In the exemplary case, although the set temperature is 600° C., the wafer center part temperature is 607° C., which is deviated from the set temperature.

Therefore, by outputting the wafer center part temperature deviation (600° C.-607° C.=−7° C.) to the upper-level controller 1300 and correcting the set temperature value, the temperature of the center part of the wafer 1400 can be adjusted to 600° C.

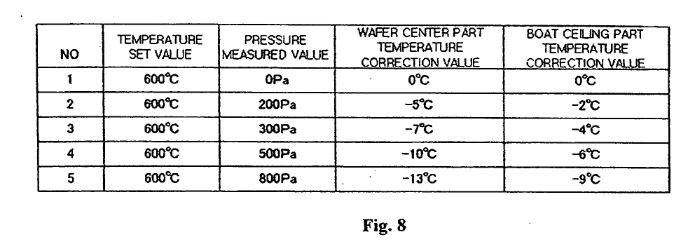

FIG. 8 shows exemplary acquired data.

Next, the calculation of a pressure correction value will be explained.

For example, a current boat ceiling part temperature deviation is denoted by t1, a current pressure set value is denoted by p1, and a boat ceiling part temperature correction value at the current pressure set value p1 is denoted by b1. In acquired data, a plus-side measured pressure value is denoted by pp, a plus-side boat ceiling part temperature correction value is denoted by tp, a minus-side measured pressure value is denoted by pm, and a minus-side boat ceiling part temperature correction value is denoted by tm. Then, a pressure correction value px can be calculated using Formula 11 or 12 below according to the values of t1 and b1.

If t1<b1,

px=(b1−t1)*{(p1−pm)/(b1−tm)} (Formula 11)

if t1>b1,

px=(b1−t1)*{(pp−p1)/(tp−b1)} (Formula 12)

Hereinafter, the cases of t1<b1 and t1>b1 will be described.

FIG. 9 is a view for explaining how the pressure correction value px is calculated for the case of t1<b I.

First, a temperature difference (b1−t1) between a previously acquired boat ceiling part temperature deviation b1 and a current boat ceiling part temperature deviation t1 is calculated.

Next, by using (p1−pm)/(b1−tm) where p1 is a current pressure set value, b1 is a boat ceiling part temperature deviation at the current pressure set value p1, pm is a minus-side pressure value, and tm is a minus-side boat ceiling part temperature deviation at the minus-side pressure value pm, a pressure correction value px per a boat ceiling part temperature deviation of +1° C. is calculated from previously acquired data.

In the example shown in FIG. 9, the boat ceiling part temperature correction value at 300 Pa is −4° C., and −6° C. is extracted in minus side thereof as shown in No. 4 of FIG. 8.

Additionally, in the previously acquired data, when the pressure set value p1 is 300 Pa, the boat ceiling part temperature deviation b1 is −4° C.

Furthermore, the pressure set value pm is 500 Pa, and, to change the temperature deviation of the boat ceiling part by +2° C. from −6° C. to −4° C., the pressure correction value needs to be:

300 Pa (p1)−500 Pa (pm)=−200 Pa.

Explanation will be given on an example where a currently measured pressure is 300 Pa and a boat ceiling part temperature deviation obtained from measured results is −5° C.

In this case, a boat ceiling part temperature correction value at a current pressure set value is used as a search key, and the closest boat ceiling part correction value is selected using the search key from the plus and minus sides of the acquired data shown in FIG. 8. Then, calculation is performed using the selected data.

From the above,

Pressure correction value per +1° C.=−200 Pa/2° C.=−100 Pa/° C.

That is, since the difference (b1-t1) to be corrected is +1° C., the pressure correction value is calculated as:

+1° C.*(−100 Pa/° C.)=−100 Pa.

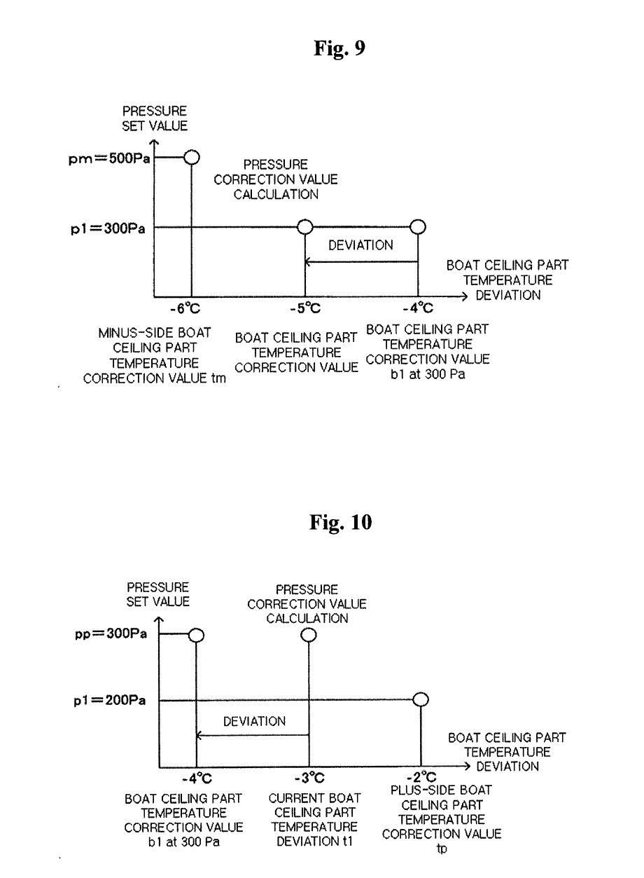

FIG. 10 is a view for explaining how the pressure correction value px is calculated for the case where t1>b1.

First, a temperature difference between a previously acquired boat ceiling part temperature deviation b1 and a current boat ceiling part temperature deviation t1 is calculated.

Next, by using (pp−p1)/(tp−b1) where p1 is a current pressure set value, b1 is a boat ceiling part temperature deviation at the current pressure set value p1, pp is a plus-side pressure value, and tp is a plus-side boat ceiling part temperature deviation at the plus-side pressure value pp, a pressure correction value px for a boat ceiling part temperature deviation of −1° C. is calculated from previously acquired data.

In an example where a currently measured pressure is 300 Pa and a boat ceiling part temperature deviation obtained from measured results is −3° C., the boat ceiling part temperature deviation b1 is −4° C. when the pressure set value pp is 300 Pa as shown in the previously acquired data of FIG. 8. In addition, when the pressure set value p1 is 200 Pa, the boat ceiling part temperature deviation tp is −2° C.

Therefore, in the previously acquired data, to change the temperature by −2° C. from the boat ceiling part temperature deviation tp of −2° C. to the boat ceiling part temperature deviation b1 of −4° C., the pressure correction value needs to be:

300 Pa (pp)−200 Pa (p1)=+100 Pa.

That is, the boat ceiling part temperature correction value at 300 Pa is −4° C., and −2° C. is extracted in plus side thereof as shown in No. 2 of FIG. 8.

From the above,

Pressure correction value per +1° C.=−100 Pa/2° C.=−50 Pa/° C.

In this example, since the desired amount of correction value is (b1−t1)=−1° C., the pressure correction value is calculated as:

−1° C.*(−50 Pa/° C.)=+50 Pa.

In the above, the pressure correction value px is explained when the boat ceiling part temperature deviation t1 and the boat ceiling part temperature correction value b1 are not equal; however, it is unnecessary to calculate the pressure correction value when t1 and b1 is equal.

Furthermore, in the calculation of the pressure correction value, the reason for calculating the pressure correction value per the boat ceiling part temperature deviation of 1° C. using the relationship among a detected plus-side or minus side pressure value, a boat ceiling part temperature deviation at the detected plus-side or minus-side pressure value, a current pressure set value p1, and a boat ceiling part temperature deviation b1 at the current pressure set value p1 is that the pressure correction value is considered to vary according to the temperature of the boat ceiling part.

For example, the pressure correction value for changing the boat ceiling part temperature correction value by +2° C. from −6° C. to −4° C. may not be always equal to the pressure correction value for changing the boat ceiling part temperature correction value by +2° C. from −4° C. to −2° C. due to variations in radiation from the heating element of the heater 1052, heat transfer from the edge part of the wafer 1400 to the reaction tube 1014, and heat transfer between the center and edge parts of the wafer 1400.

Therefore, in the semiconductor manufacturing apparatus 1010 relevant to the current embodiment, to calculate a pressure correction value using variations of close boat ceiling part temperature correction values, a pressure correction value is calculated using a minus-side boat ceiling part temperature deviation and a pressure set value if a current boat ceiling part temperature deviation is smaller than a boat ceiling part temperature deviation at a current pressure set value, and a pressure correction value is calculated using a plus-side boat ceiling part temperature deviation and a pressure set value if a current boat ceiling part temperature deviation is greater than a boat ceiling part temperature deviation at a current pressure set value.

For the above-described semiconductor manufacturing apparatus 1010 relevant to the first type to which the present invention is applied, research has been conducted to suppress uneven thickness of a film formed on a wafer 1400; however, unevenness problems still arise in a thin film formed on the wafer 1400.

Furthermore, in the above-described semiconductor manufacturing apparatus 1010 relevant to the first type to which the present invention is applied, since a temperature is detected from only a part of the circumference of the wafer 1400, there is a problem in that a temperature difference along the circumference of the wafer 1400 may not be reduced.

Moreover, in the above-described semiconductor manufacturing apparatus 1010 relevant to the first type to which the present invention is applied, it is difficult to control the temperature of the wafer 1400 and continue processing of the wafer 1400 when one of a plurality of temperature sensors is out of order.

Therefore, in a semiconductor manufacturing apparatus 1010 (described later) relevant to first and second embodiments of the present invention, the above-described problems are removed through further peculiar research.

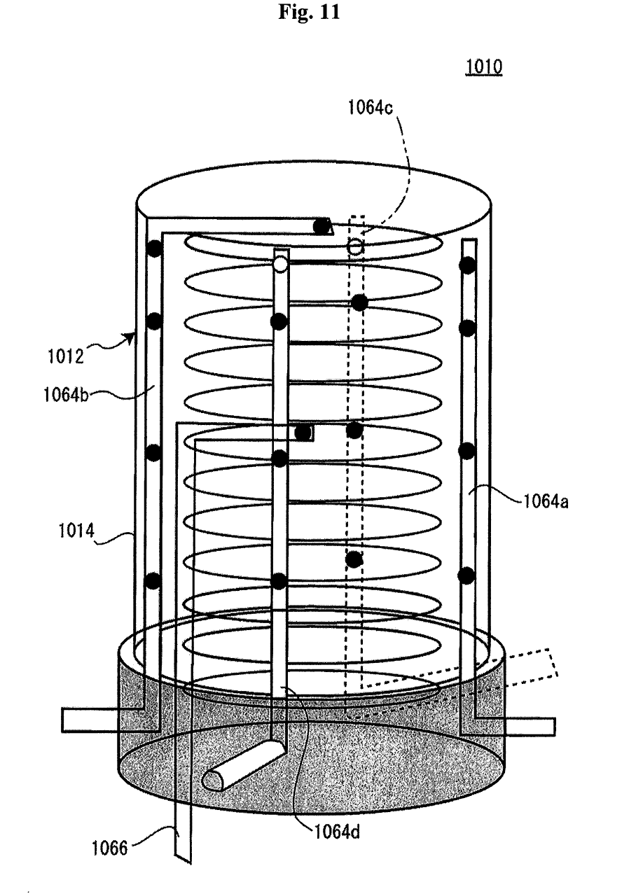

FIG. 11 illustrates a main part of a semiconductor manufacturing apparatus 1010 relevant to a first embodiment of the present invention.

like in the first type to which the present invention is applied, the semiconductor manufacturing apparatus 1010 relevant to the first embodiment of the present invention includes a heater 1052 coaxially disposed at the outside of a reaction tube 1014, a first thermocouple 1062, second thermocouples 1064, and a third thermocouple 1066 (refer to FIG. 1).

As explained above, in the first type to which the present invention is applied, a second thermocouple 1064 is installed at the circumference of a wafer 1400. However, in the first embodiment, a plurality of second thermocouples 1064 are installed.

That is, as shown in FIG. 11, the semiconductor manufacturing apparatus 1010 relevant to the first embodiment includes a second main thermocouple 1064a (hereinafter, referred to as a inner main thermocouple), a second sub thermocouple 1064b (hereinafter, referred as an inner sub thermocouple), and second two thermocouples 1064c and 1064d (hereinafter, referred to as inner side thermocouples) that are disposed between the inner main thermocouple 1064a and the inner sub thermocouple 1064b along the circumference of the wafer 1400. The second thermocouple 1064 may be formed integral with a ceiling thermocouple.

Here, the inner main thermocouple 1064a, the inner sub thermocouple 1064b, the inner side thermocouple 1064c, and the inner side thermocouple 1064d are installed, for example, between the reaction tube 1014 and a boat 1044 (refer to FIG. 1), and are used for detecting temperatures inside the reaction tube 1014. As shown by black spots in FIG. 11, each of the inner main thermocouple 1064a, the inner sub thermocouple 1064b, the inner side thermocouple 1064c, and the inner side thermocouple 1064d includes a plurality of (e.g., four) temperature detecting points in a vertical direction for detecting temperatures at a plurality of positions.

Preferably, the inner main thermocouple 1064a, the inner sub thermocouple 1064b, the inner side thermocouple 1064c, and the inner side thermocouple 1064d have the same number of temperature detecting points, and in the first embodiment, each of the thermocouples 1064a, 1064b, 1064c, and 1064d has four temperature detecting points. In addition, it is preferable that the temperature detecting points of the inner main thermocouple 1064a, the inner sub thermocouple 1064b, the inner side thermocouple 1064c, and the inner side thermocouple 1064d be in the same positions (heights) in the gravitational direction, and by this positioning in the gravitational direction, precision in temperature control can be improved (described later). That is, heater temperature control is performed using the average of temperatures detected from the temperature detecting points of the second thermocouples 1064 having the same height.

The third thermocouple 1066 is installed between the reaction tube 1014 and the boat 1044 at a position closer to the boat 1044 than the inner main thermocouple 1064a, the inner sub thermocouple 1064b, the inner side thermocouple 1064c, and the inner side thermocouple 1064d, so as to detect a temperature at a position close to the boat 1044.

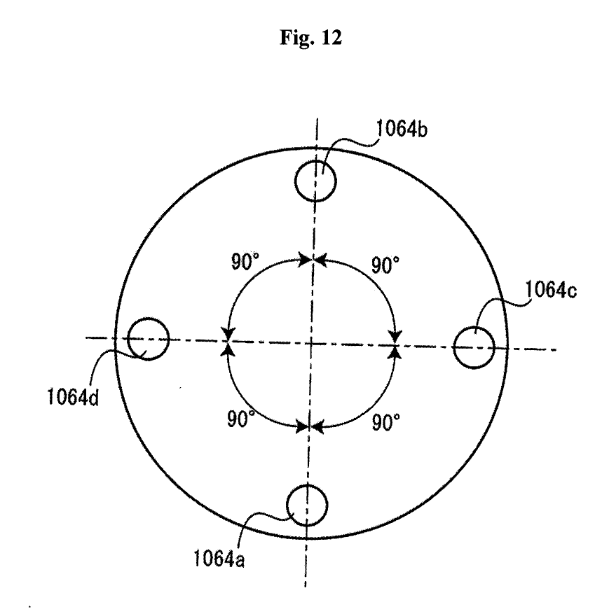

FIG. 12 is a schematic view illustrating arranged positions of the second thermocouples 1064 on a plane. As shown in FIG. 12, the inner main thermocouple 1064a, the inner sub thermocouple 1064b, the inner side thermocouple 1064c, and the inner side thermocouple 1064d are arranged on a plane parallel with the surface of the wafer 1400 along the circumference of the wafer 1400 at regular intervals. That is, the inner main thermocouple 1064a, the inner sub thermocouple 1064b, the inner side thermocouple 1064c, and the inner side thermocouple 1064d are arranged along the same circumference, and neighboring two of them form an angle of about 90° about the center of the circumference. By arranging the inner main thermocouple 1064a, the inner sub thermocouple 1064b, the inner side thermocouple 1064c, and the inner side thermocouple 1064d along the circumference of the wafer 1400 at regular intervals, the average temperature of the periphery of the wafer 1400 can be detected.

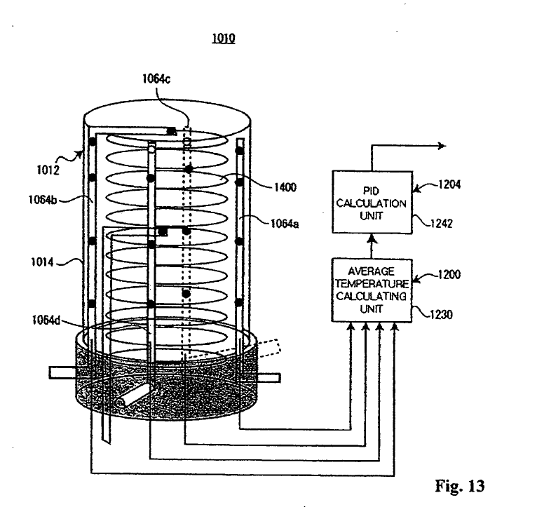

FIG. 13 is a view for explaining a control method and configuration for the semiconductor manufacturing apparatus 1010. As explained above, in the first type to which the present invention is applied, the semiconductor manufacturing apparatus 1010 includes a second thermocouple 1064 and performs a control operation using the second thermocouple 1064. However, in the semiconductor manufacturing apparatus 1010 relevant to the first embodiment, the average of temperatures measured by a plurality of second thermocouples 1064 is used for controlling an operation.

Specifically, as shown in FIG. 13, outputs of the inner main thermocouple 1064a, the inner sub thermocouple 1064b, the inner side thermocouple 1064c, and the inner side thermocouple 1064d are input to an average temperature calculating unit 1230 of a control unit 1200, and the average temperature calculating unit 1230 calculates the average of the input values and outputs the calculated average to a PID calculating unit 1242 of a temperature control unit 1204, so that the output of the PID calculating unit 1242 can be used for controlling such as controlling of a heater 1052.

For example, the temperature of the circumference of the wafer 1400 can be controlled by averaging temperatures detected at four temperature detecting points of the second thermocouples 1064 having the same height, and performing a PID-control operation to make deviation of a temperature set value zero.

In this way, temperatures measured from equal-height temperature detecting points of the second thermocouples 1064 arranged along the circumference of the wafer 1400 are averaged and used for temperature controlling, so that when the boat 1044 is rotated, the temperature of the vicinity of the edge part (peripheral part) of the wafer 1400 can be predicted, and thus the edge part of the wafer 1400 can be controlled using a more proper value.

In the above-described semiconductor manufacturing apparatus 1010 relevant to the first embodiment, since the average of temperatures detected from equal-height temperature detecting points of the plurality of second thermocouples 1064 are used for controlling, if one or more of the equal-height temperature detecting points of the plurality of second thermocouples 1064 are defective, the control operation is performed using the average obtained from the remaining non-defective temperature detecting points of the second thermocouples 1064. In this case, due to a temperature deviation along the circumference of the wafer 1400, the edge part of the wafer 1400 may not be controlled to a proper temperature.

Therefore, in a second embodiment of the present invention (described later), controlling can be properly performed even when one of the second thermocouples 1064 is out of order, by using a method attained through peculiar research.

The semiconductor manufacturing apparatus 1010 relevant to the first embodiment of the present invention has the same structure as the semiconductor manufacturing apparatus 1010 relevant to the first type to which the present invention is applied, except for the above-descried peculiar structure, and thus a description of the same structure is omitted.

Next, the semiconductor manufacturing apparatus 1010 relevant to the second embodiment of the present invention will be described. FIG. 14 is a view for explaining a control method and configuration in the semiconductor manufacturing apparatus 1010 relevant to the second embodiment of the present invention. In the following explanation on the semiconductor manufacturing apparatus 1010 relevant to the second embodiment, descriptions of the same structures as those of the semiconductor manufacturing apparatus 1010 relevant to the first embodiment will be omitted.

The semiconductor manufacturing apparatus 1010 relevant to the second embodiment has a recovery function: correction values are previously calculated for set values of a plurality of temperature detecting points of a plurality of second thermocouples 1064, and when one of the temperature detecting points of the second thermocouples 1064 is defective, a temperature to be detected at the defective detecting point is predicted using the previously calculated correction value.

That is, in the semiconductor manufacturing apparatus 1010 relevant to the second embodiment, when a control operation is performed based on a predetermined set temperature, the average value of outputs of the temperature detecting points of the second thermocouples 1064, and deviations (correction values) of the outputs of the temperature detecting points of the second thermocouples 1064 from the average value are acquired.

Therefore, when any point of the temperature detecting points of the second thermocouples 1064 is defective, a temperature that may be detected from the defective point if the point is not defective is predicted using the set temperature and the correction value, and the predicted temperature is used, so that the edge part of a wafer 1400 can be continuously controlled to a proper temperature, and thus the reproducibility of the thickness and quality of a thin film formed on the wafer 1400 can be improved.

This will be described hereinafter in more detail with reference to FIG. 14.

Here, explanation will be given on an example in which a control operation with a set temperature of 600° C. is performed using a temperature calculated by averaging temperatures measured by a plurality of temperature detecting points of an inner main thermocouple 1064a, an inner sub thermocouple 1064b, an inner side thermocouple 1064c, and an inner side thermocouple 1064d.

As shown in FIG. 14, outputs of the inner main thermocouple 1064a, the inner sub thermocouple 1064b, the inner side thermocouple 1064c, and the inner side thermocouple 1064d are input to a calculation-memory unit 1250 of a control unit 1200. The calculation-memory unit 1250 receives a set temperature from an upper-level controller 1300. In addition, an average value calculated by the calculation-memory unit 1250 is output to a PID calculation unit 1242, and an output of the PID calculation unit 1242 is used for a control operation, for example, to control a heater 1052.

In this example, a control operation is performed to make an average temperature 600° C., and thus 600° C. is input from the upper-level controller 1300 to the calculation-memory unit 1250 as a set temperature. In the following description, output values from the inner main thermocouple 1064a, the inner sub thermocouple 1064b, the inner side thermocouple 1064c, and the inner side thermocouple 1064d will be referred to as a main output value, a sub output value, a side output value 1, and a side output value 2, respectively. Temperature detecting points of the second thermocouples 1064 are substantially at the same heights.

An explanation will be given on an example in which the main output value is 600.0° C., the sub output value is 599.5° C., the side output value 1 is 602.0° C., and the side output value 2 is 598.5° C.

Based on values received from the inner main thermocouple 1064a, the inner sub thermocouple 1064b, the inner side thermocouple 1064c, and the inner side thermocouple 1064d, and a value received from the upper-level controller 1300, the calculation-memory unit 1250 calculates deviations (correction values) of the output values of the second thermocouples 1064 from a set value.

That is, a correction value (hereinafter, referred to as a main correction value) of the inner main thermocouple 1064a, a correction value (hereinafter, referred to as a sub correction value) of the inner sub thermocouple 1064b, a correction value (hereinafter, referred to as a side correction value 1) of the inner side thermocouple 1064c, and a correction value (hereinafter, referred to as a side correction value 2) of the inner side thermocouple 1064d are calculated as follows.

main correction value=main output value−average value

sub correction value=sub output value−average value

side correction value 1=side output value 1−average value

side correction value 2=side output value 2−average value

more specifically,

main correction value=600.0° C.−600° C.=0.00° C.

sub correction value=599.5° C.−600° C.=−0.50° C.

side correction value 1=602.0° C.−600° C.=2.00° C.

side correction value 2=598.5° C.−600° C.=−1.50° C.

The above-calculated results are stored in the calculation-memory unit 1250.

Next, an explanation will be given on the case where one of the inner main thermocouple 1064a, the inner sub thermocouple 1064b, the inner side thermocouple 1064c, and the inner side thermocouple 1064d is out of order. For example, the case where the inner side thermocouple 1064d is out of order will be explained.

If the inner side thermocouple 1064d is out of order, a peripheral temperature cannot be detected using the inner side thermocouple 1064d, and thus an average value cannot be calculated using the four second thermocouples 1064, so that it is impossible to perform a control operation in the semiconductor manufacturing apparatus 1010 relevant to the first embodiment.

Therefore, in the semiconductor manufacturing apparatus 1010 relevant to the second embodiment, a side correction value 2 previously stored in the calculation-memory unit 1250 is used to predict a value that may be output from the inner side thermocouple 1064d if the inner side thermocouple 1064d is not out of order, and the average of temperatures at equal-height temperature detecting points of the four second thermocouples 1064 is calculated.

That is,

predicted value as side output value 2=set value +side correction value 2

Specifically,

predicted value as side output value 2=600.0° C.+(−1.50° C.)=598.5° C.

By using the predicted value, the average of temperatures at equal-height temperature detecting points of the four second thermocouples 1064 is calculated.

Here, when the inner side thermocouple 1064d is out of order, the average of temperatures at equal-height temperature detecting points of the four second thermocouples 1064 is calculated using Formula below:

Average=(main output value +sub output value +side output value 1+predicted value as side output value 2)/4

Although the above-explanation is given on the case where one of equal-height temperature detecting points of the four second thermocouples 1064 is out of order, in the case where two or more of the equal-height temperature detecting points of the four second thermocouples 1064, an average value is calculated in the same manner as that described above. For example, if the inner sub thermocouple 1064b as well as the inner side thermocouple 1064d is out of order, a sub output value is also predicted, and the average of temperatures at equal-height temperature detecting points of the four second thermocouples 1064 is calculated.

That is,

predicted value as sub output value=set value +sub correction value, and

average=(main output value +predicted value as sub output value +side output value 1+predicted value as side output value 2)/4.

Next, a semiconductor manufacturing apparatus 1 will be described according to a second type to which the present invention is applied.

[Semiconductor Processing Apparatus 1]

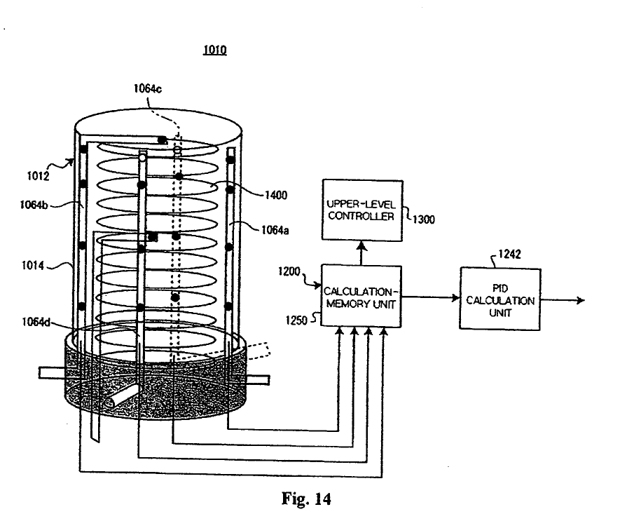

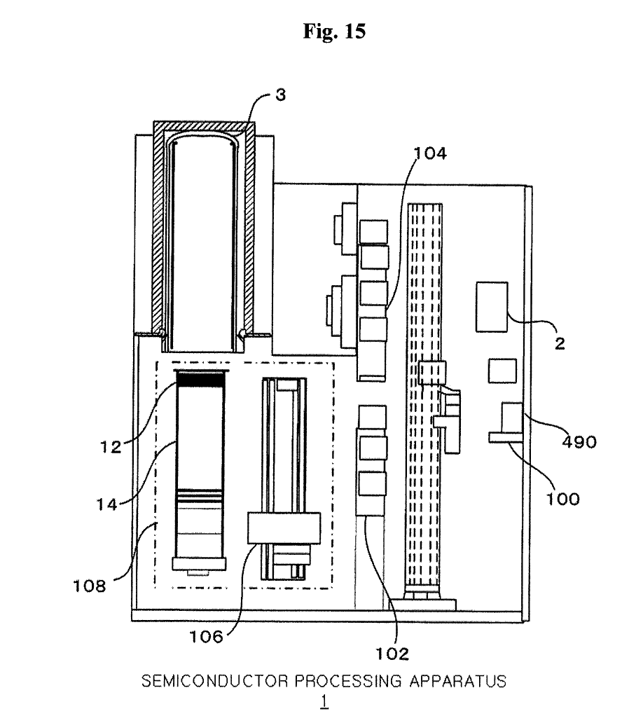

FIG. 15 illustrates the overall structure of a semiconductor processing apparatus 1 relevant to a second type to which the present invention is applied.

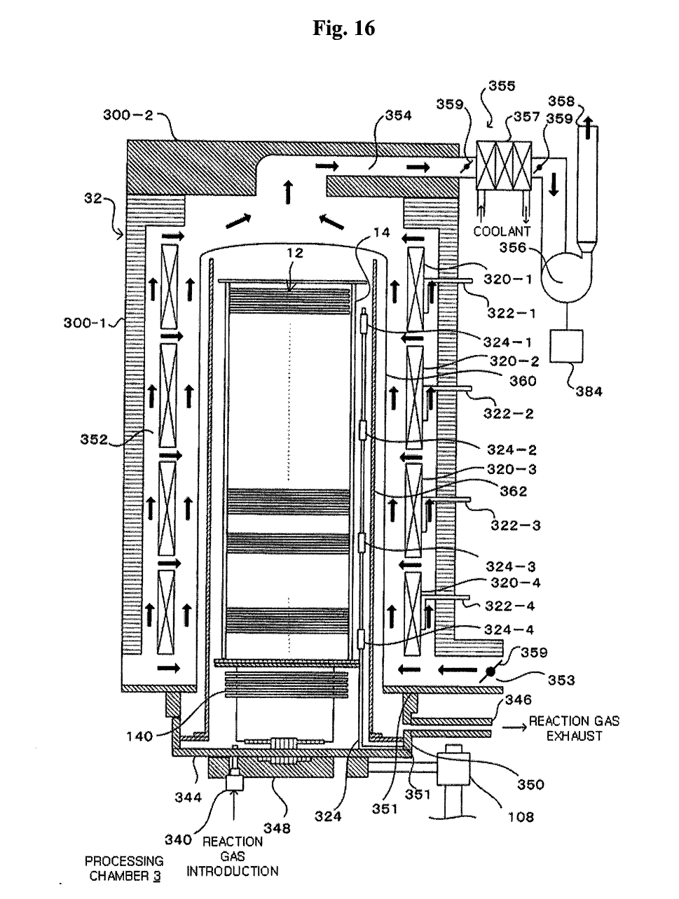

FIG. 16 exemplarily illustrates a processing chamber 3 of FIG. 15, in which a boat 14 and wafers 12 are loaded.

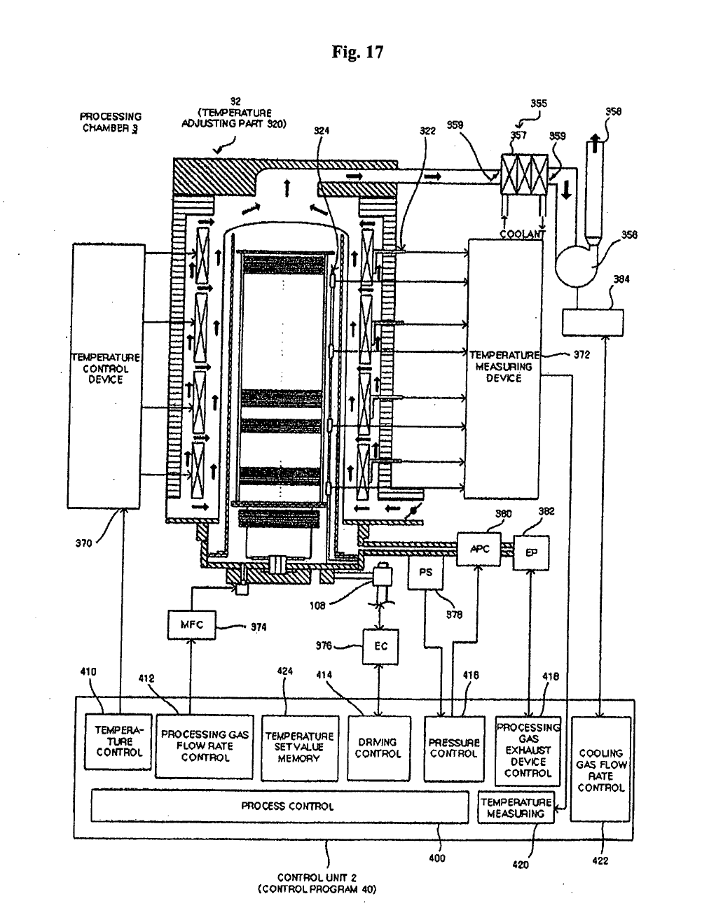

FIG. 17 illustrates nearby parts of the processing chamber 3 depicted in FIG. 15 and FIG. 16, and a structure of a first control program 40 used to control the processing chamber 3.

The semiconductor processing apparatus 1 is a semiconductor manufacturing apparatus, for example, a low pressure chemical vapor deposition (CVD) apparatus for processing a substrate such as a semiconductor substrate.

As shown in FIG. 15, the semiconductor processing apparatus I is configured by a cassette transfer unit 100, a cassette stoker 102 installed at the backside of the cassette transfer unit 100, a buffer cassette stoker 104 installed at the upside of the cassette stoker 102, a wafer mover 106 installed at the backside of the cassette stoker 102, a boat elevator 108 installed at the backside of the wafer mover 106 for carrying a boat 14 in which wafers 12 are set, and a processing chamber 3 installed at the upside of the wafer mover 106, and a control unit 2 (control device).

[Processing Chamber 3]

As shown in FIG. 16, the processing chamber 3 illustrated in FIG. 15 is configured by a hollow heater 32, an outer tube 360, an inner tube 362, a gas introducing nozzle 340, a furnace port cover 344, an exhaust pipe 346, a rotation shaft 348, a manifold 350 made of a material such as a stainless material, O-rings 351, a cooling gas passage 352, an exhaust passage 354, an exhaust unit 355 (exhaust device), and other parts such as a processing gas flow rate control device (described later with reference to FIG. 17). The lateral side of the processing chamber 3 is covered with an insulating material 300-1, and the topside of the processing chamber 3 is covered with an insulating material 300-2.

Furthermore, at the bottom side of the boat 14, a plurality of insulating plates 140 are installed.

The outer tube 360 is made of a transparent material such as quartz and has a cylindrical shape with a lower opening.

The inner tube 362 is made of a transparent material such as quartz, formed into a cylindrical shape, and coaxially disposed inside the outer tube 360.

Therefore, between the outer tube 360 and the inner tube 362, a cylindrical tube shaped space is formed.

The heater 32 includes four temperature adjusting parts (U, CU, CL, and L) 320-1 to 320-4 that face each other and allow temperature setting and adjustment, outer temperature sensors 322-1 to 322-4 such as thermocouples disposed between the outer tube 360 and the heater 32, inner temperature sensors (in-furnace TC) 324-1 to 324-4 such as thermocouples disposed inside the outer tube 360 in correspondence with the temperature adjusting parts 320-1 to 320-4.

The inner temperature sensors 324-1 to 324-4 may be disposed inside the inner tube 362 or between the inner tube 362 and the outer tube 360, bent at the respective temperature adjusting parts 320-1 to 320-4, and installed to measure temperatures of the center parts of the wafers 12 at positions between the wafers 12.

For example, each of the temperature adjusting parts 320-1 to 320-4 of the heater 32 emits light toward the periphery of the outer tube 360 to optically heat the wafers 12, and thus the wafers 12 is increased in temperature (is heated) by light passing through the outer tube 360 and absorbed into the wafers 12.

The cooling gas passage 352 is formed between the insulating material 300-1 and the outer tube 360 to pass a fluid such as cooling gas therethrough, and cooling gas supplied from an inlet port 353 formed at the bottom side of the insulating material 300-1 passes through the cooling gas passage 352 toward the upper side of the outer tube 360.

For example, the cooling gas is air or nitrogen (N₂).

In addition, the cooling gas passage 352 is configured so that the cooling gas flows between the temperature adjusting parts 320-1 to 320-4 toward the outer tube 360.

The cooling gas cools the outer tube 360, and the cooled outer tube 360 cools the wafers 12 set inside the boat 14 from the circumference (periphery) of the wafers 12.

That is, by the cooling gas passing through the cooling gas passage 352, the outer tube 360 and the wafers 12 set in the boat 14 are cooled from the circumferences (peripheries) thereof.

At the topside of the cooling gas passage 352, the exhaust passage 354 is installed as a cooling gas exhaust passage. The exhaust passage 354 guides the cooling gas, supplied from the inlet port 353 and passed upward through the cooling gas passage 352, to the outside of the insulating material 300-2.

Furthermore, at the exhaust passage 354, the exhaust unit 355 is installed to exhaust cooling gas.

The exhaust unit 355 includes a cooling gas exhaust device 356 used as a cooling device and comprised of a blower or the like, and a radiator 357, and is configured to exhaust cooling gas, guided by the exhaust passage 354 to the outside of the insulating material 300-2, through an exhaust port 358.

The radiator 357 cools cooling gas, which is heated while cooling the outer tube 360 and the wafers 12 in the processing chamber 3, by using a coolant.

At the vicinities of the inlet port 353 and the radiator 357, shutters 359 are respectively installed and are controlled by a shutter control unit (shutter control device, not shown) to close/open the cooling gas passage 352 and the exhaust passage 354.

As shown in FIG. 17, the processing chamber 3 is additionally provided with a temperature control device 370, a temperature measuring device 372, a processing gas flow rate control device (mass flow controller, MFC) 374, a boat elevator control device (elevator controller, EC) 376, a pressure sensor (PS) 378, an pressure regulating device (auto pressure control (APC) (value)) 380, a processing gas exhaust device (EP) 382, and an inverter 384.

The temperature control device 370 operates the respective temperature adjusting parts 320-1 to 320-4 under the control of the control unit 2 (control device).

The temperature measuring device 372 detects temperatures of the respective temperature sensors 322-1 to 322-4 and 324-1 to 324-4 and outputs the detected temperatures to the control unit 2 as measured temperature values.

The boat elevator control device (EC) 376 operates the boat elevator 108 under the control of the control unit 2.

For example, as the pressure regulating device 380 (hereinafter, referred to as an APC), an APC, a N₂ ballast controller, or the like is used.

As the processing gas exhaust device (EP) 382, a vacuum pump or the like is used.

The inverter 384 controls the blower speed of the cooling gas exhaust device 356.

[Control Unit 2]

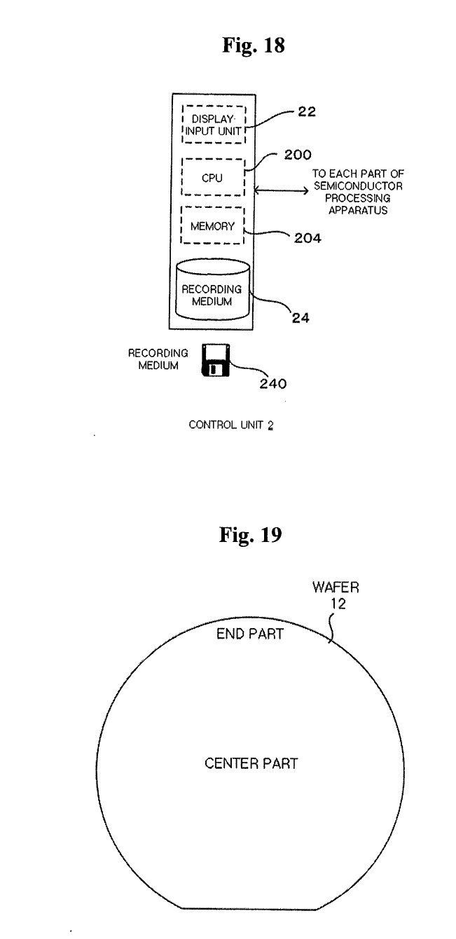

FIG. 18 illustrates the configuration the control unit 2 of FIG. 15.

As shown in FIG. 18, the control unit 2 is configured by: a CPU 200; a memory 204; a display-input unit 22 (input device) including a display device, a touch panel, a keyboard-mouse, etc.; and a recording unit 24 (recording device) such as an HD and a CD.

That is, the control unit 2 includes parts of a general computer for controlling the semiconductor processing apparatus 1.

The control unit 2 executes a low pressure CVD control program (e.g., the control program 40 of FIG. 17) using its parts, so as to control each part of the semiconductor processing apparatus 1 and perform a low pressure CVD process (described later) on the wafers 12.

[First Control Program 40]

Explanation will be given with reference again to FIG. 17.

As shown in FIG. 17, the control program 40 is configured by a process control part 400 (process control device), a temperature control part 410 (temperature control device), a processing gas flow rate control part 412 (processing gas flow rate control device), a driving control part 414 (driving control device), a pressure control part 416 (pressure control device), a processing gas exhaust device control part 418 (processing gas control device), a temperature measuring part 420 (temperature measuring device), a cooling gas flow rate control part 422 (cooling gas control unit), and a temperature set value memory part 424 (temperature set value memory device).

The control program 40 is provided to the control unit 2 via, for example, a recording medium 240 (refer to FIG. 18) and is loaded and executed on the memory 204.

The temperature set value memory part 424 stores a temperature set value of a recipe for processing the wafers 12 and outputs the temperature set value to the process control part 400.

The process control part 400 controls parts of the control unit 2, for example, according to a user's manipulation using the display-input unit 22 (refer to FIG. 18) of the control unit 2 or a processing sequence (processing recipe) recorded in the recording unit 24 of the control unit 2, and performs a low pressure CVD process on the wafers 12 as described later.

The temperature measuring part 420 receives measured temperature values from temperature sensors 322 and 324 through the temperature measuring device 372 and outputs the measured temperature values to the process control part 400.

The temperature control part 410 receives a temperature set value and temperature values measured by the temperature sensors 322 and 324 from the process control part 400 for controlling power to the temperature adjusting parts 320 through feedback and heating the inside of the outer tube 360 to keep the wafers 12 at a desired temperature.

The processing gas flow rate control part 412 controls the MFC 374 to adjust the flow rate of processing gas or inert gas supplied to the inside of the outer tube 360.

The driving control part 414 controls the boat elevator 108 to vertically move the boat 14 and the wafers 12 held in the boat 14.

In addition, the driving control part 414 controls the boat elevator 108 to rotate the boat 14 and the wafers 12 held in the boat 14 via the rotation shaft 348.

The pressure control part 416 receives a pressure value of processing gas inside the outer tube 360 measured by the PS 378 and controls the APC 380 to keep the processing gas inside the outer tube 360 at a desired pressure level.

The processing gas exhaust device control part 418 controls the EP 382 and exhausts the processing gas or inert gas from the inside of the outer tube 360.

The cooling gas flow rate control part 422 controls the cooling gas exhaust device 356 through the inverter 384 to adjust the flow rate of cooling gas discharged through the cooling gas exhaust device 356.

In the following description, when one of a plurality parts such as the temperature adjusting parts 320-1 to 320-4 is referred to, it may simply be referred to as a temperature adjusting part 320.

Furthermore, in the following description, parts such as the temperature adjusting parts 320-1 to 320-4 may be described in plurality; however, such specific numbers are exemplarily used to provide a specific and clear explanation, and it will be understood that the scope of the present invention should not be limited thereto.

Between the bottom side of the outer tube 360 and an upper opening of the manifold 350, and the furnace port cover 344 and a lower opening of the manifold 350, the O-rings 351 are disposed so that the joint part between the outer tube 360 and the manifold 350 can be securely sealed.

Through the gas introducing nozzle 340 located at the downside of the outer tube 360, inert gas or processing gas is introduced into the outer tube 360.

To the upper part of the manifold 350, the exhaust pipe 346 (refer to FIG. 16) connected to the PS 378, the APC 380, and the EP 382 is attached.

Processing gas passing between the outer tube 360 and the inner tube 362 is discharged to the outside through the exhaust pipe 346, the APC 380, and the EP 382.

Based on the inside pressure of the outer tube 360 measured using the PS 378, the APC 380 is controlled by the pressure control part 416 so that the pressure inside the outer tube 360 can be adjusted to a preset desired pressure.

That is, when inert gas is introduced to make the pressure inside the outer tube 360 equal to atmospheric pressure, the APC 380 is controlled according to the instruction of the pressure control part 416 to adjust the pressure inside the outer tube 360 to atmospheric pressure, or when processing gas is introduced to process the wafers 12 under a condition where the pressure inside the outer tube 360 is low, the APC 380 is controlled according to the instruction of the pressure control part 416 to adjust the pressure inside the outer tube 360 to a lower level.

To the bottom side of the boat 14 where a plurality of wafers 12 are held, the rotation shaft 348 is connected.

In addition, the rotation shaft 348 is connected to the boat elevator 108 (refer to FIG. 15), and the boat elevator 108 moves the boat 14 upwardly and downwardly at a predetermined speed according to a control instruction via the EC 376.

Furthermore, the boat elevator 108 rotates the wafers 12 and the boat 14 at a predetermined speed through the rotation shaft 348.

The wafers 12, which are process target objects and are used as substrates, are charged in a wafer cassette 490 (refer to FIG. 15) and are carried to the cassette transfer unit 100.

The cassette transfer unit 100 transfers the wafers 12 to the cassette stoker 102 or the buffer cassette stoker 104.

The wafer mover 106 picks up the wafers 12 from the cassette stoker 102 and charges the wafers 12 into the boat 14 horizontally in multiple stages.

The boat elevator 108 lifts the boat 14 charged with the wafers 12 into the processing chamber 3.

Furthermore, after a processing operation, the boat elevator 108 lowers the boat 14 charged with the wafers 12 to take the boat 14 out of the processing chamber 3.

### [Temperature and Film Thickness of Wafer 12]

FIG. 19 illustrates an exemplary shape of a wafer 12 that is a processing object of the semiconductor processing apparatus 1 of FIG. 15.

The surface of the wafer 12 (hereinafter, the surface of the wafer 12 will be also referred to as the wafer 12 simply) is shaped as shown in FIG. 19, and the wafer 12 is horizontally held in the boat 14.

The wafer 12 is heated from a part adjacent to the outer tube 360 by light emitted from the temperature adjusting parts 320-1 to 320-4 and transmitted through the outer tube 360.

Therefore, the edge part of the wafer 12 absorbs a large amount of light, and if cooling gas does not flow through the cooling gas passage 352, the temperature of the edge part of the surface of the wafer 12 is higher than the center part of the surface of the wafer 12.

That is, due to heating by the temperature adjusting parts 320-1 to 320-4, the temperature of the wafer 12 increases as it goes closer to the periphery of the wafer 12 and decreases as it goes closer to the center of the wafer 12, and thus the temperature distribution of the wafer 12 is shaped like a bowl from the edge part to the center part of the wafer 12.

Moreover, since processing gas such as reaction gas is supplied to the wafer 12 from the periphery of the wafer 12, a reaction speed may vary from the edge part to the center part of the wafer 12 depending on the kind of a film formed on the wafer 12.

For example, since processing gas such as reaction gas is first consumed at the edge part of the wafer 12 and arrives at the center part of the boat 14, the density of the processing gas is lower at the center part of the wafer 12 than at the edge part of the wafer 12.

Therefore, although there is no temperature deviation between the edge part and the center part of the wafer 12, the thickness of a film formed on the wafer 12 may be non-uniform from the edge part to the center part of the wafer 12 because the reaction gas is supplied from the edge part of the wafer 12.

Meanwhile, owing to cooling gas passing through the cooling gas passage 352, the outer tube 360 and the wafer 12 set in the boat 14 are cooled from the circumference (periphery) of the outer tube 360 as described above. That is, in the processing chamber 3, the center part of the wafer 12 is heated by the temperature adjusting part 320 to a predetermined set temperature (processing temperature), and if necessary, cooling gas is allowed to flow through the cooling gas passage 352 to cool the periphery of the wafer 12, so that different temperatures can be set for the center part and edge part of the wafer 12.

To uniformly form a film on the wafer 12 as described above, heating control (including heating control and cooling control) is performed to adjust the thickness of the film according to the speed of a film forming reaction on the wafer 12. The heating control is performed by the control unit 2 in at least one of two ways: a way of controlling the temperature adjusting part 320 of the heater 32 using a temperature measured by the inner temperature sensor 324, and a way of controlling the cooling gas exhaust device 356 through the cooling gas flow rate control part 422 and the inverter 384.

[Concept of Low Pressure CVD by Semiconductor Processing Apparatus 1]

Under the control of the control program 40 executing on the control unit 2 (refer to FIG. 15 and FIG. 18), the semiconductor processing apparatus 1 is used to form films such as a Si₃N₄ film, a SiO₂ film, and a poly-Si film, by a CVD method, on semiconductor wafers 12 arranged in the processing chamber 3 at predetermined intervals.

Film formation using the processing chamber 3 will be explained again.

First, the boat elevator 108 lowers the boat 14.

A desired number of wafers 12 which are processing objects are set in the boat 14, and the boat 14 holds the set wafers 12.

Next, the four temperature adjusting parts 320-1 to 320-4 of the heater 32 are respectively operated according to set conditions to heat the inside of the outer tube 360 so as to heat the center parts of the wafers 12 to a predetermined temperature.

Meanwhile, through the cooling gas passage 352, cooling gas flows according to set conditions so as to cool the outer tube 360 and the wafers 12 set in the boat 14 from the circumferences (peripheries) thereof.

Thereafter, the MFC 374 controls the flow rate of gas introduced through the gas introducing nozzle 340 (refer to FIG. 16) and introduces inert gas into the outer tube 360 to fill the inside to the outer tube 360.

The boat elevator 108 lifts the boat 14 into the outer tube 360 filled with the inert gas having a desired processing temperature.

After that, the inert gas is exhausted from the outer tube 360 by the EP 382 to form a vacuum inside the outer tube 360, and the boat 14 and the wafers 12 held in the boat 14 are rotated via the rotation shaft 348.

In this state, processing gas is introduced into the outer tube 360 through the gas introducing nozzle 340, and then the processing gas flows upward inside the outer tube 360 and is uniformly supplied to the wafers 12.

During the low pressure CVD process, the EP 382 exhausts the processing gas from the inside of the outer tube 360 through the exhaust pipe 346, and the APC 380 adjusts the pressure of the processing gas inside the outer tube 360 to a desired level.

In this way, the low pressure CVD process is performed on the wafers 12 for a predetermined time.

After the lower pressure CVD process, to process the next wafers 12, the processing gas inside the outer tube 360 is replaced with inert gas, and the pressure inside the outer tube 360 is returned to atmospheric pressure.

In addition, cooling gas is allowed to flow through the cooling gas passage 352 to cool the inside of the outer tube 360 to a predetermined temperature.

In this state, the boat 14 and the completely-processed wafers 12 held in the boat 14 are moved downward by the boat elevator 108 to the outside of the outer tube 360.

Then, the boat elevator 108 lifts the boat 14 in which the next wafers 12 to be processed by the low pressure CVD method, and sets the boat 14 inside the outer tube 360.

On the next wafers 12, the low pressure CVD process is performed.

By supplying cooling gas before the processing of the wafers 12 and allowing the cooling gas to flow until the wafers 12 is completely processed, the thickness of films formed on the wafers 12 can be controlled; however, it is preferable that the cooling gas be allowed to flow when the boat 14 in which the wafers 12 are set is moved into the outer tube 360 and the boat 14 is moved out of the outer tube 360.

Then, since heat stays in the processing chamber 3 owing to the heat capacity of the processing chamber 3, temperature variations can be prevented and throughput can be improved.

In the above-described film forming process, while the heater 32 is controlled to keep the center parts of the wafers 12 constant at a set temperature, temperature control is performed using cooling gas to keep the edge parts (peripheral parts) of the wafers 12 at a temperature different from that of the center parts of the wafers 12, so that the film thickness uniformity of the wafers 12 can be improved without changing the film quality of the wafers 12, and moreover, the interfacial film thickness uniformity of the wafers 12 can be improved.

For example, in the case of forming CVD films such as Si₃N₄ films, if the film forming process is performed while varying the processing temperature, the refractive index of the films varies according to the processing temperature, and if the film forming process is performed while lowing the processing temperature from a high temperature to a lower temperature, the etching rate varies from a lower film to a higher film according to the processing temperature.

In addition, if Si₃N₄ films are formed while lowing the processing temperature from a high temperature to a low temperature, stress level varies from a higher film to a lower film according to the processing temperature.

Therefore, in the semiconductor processing apparatus 1, the control unit 2 controls the temperature of the outer tube 360 by adjusting the temperature of the temperature adjusting part 320 and the flow rate of cooling gas passing through the cooling gas passage 352, and thus, the temperature in the surfaces of substrates such as wafers 12 can be controlled, so that the thickness uniformity of films formed on the substrate can be controlled while preventing variations of film quality.

[Exhaust Pressure and Film Thickness]

As described above, when a film is formed on the wafers 12 in the semiconductor processing apparatus 1, the control unit 2 controls the temperature adjusting part 320 of the heater 32 using a temperature measured by the inner temperature sensor 324, or controls the cooling gas exhaust device 356 through the cooling gas flow rate control part 422 and the inverter 384, so that heating is controlled by at least one of the above ways. Thus, when cooling gas flows through the cooling gas passage 352, the exhaust unit 355 exhausts the cooling gas from the cooling gas path 352 through the exhaust path 354 and the exhaust port 358. To the exhaust port 358, exhaust equipment (not shown) such as plant exhaust equipment is connected. The exhaust equipment sucks the cooling gas from the exhaust passage 354 at an equipment exhaust pressure to enable exhaustion from the exhaust passage 354.

Since the equipment exhaust pressure is determined by a conductance varying according to a pipe distance, a pipe shape, a pipe passage, etc. from the exhaust equipment to the exhaust port 358, or by the number of devices connected to the plant exhaust equipment, the equipment exhaust pressure is different from equipment to equipment and may vary in the same equipment.

If the equipment exhaust pressure varies, the amount of gas flowing through the cooling gas passage 352 varies although the same amount of cooling gas is supplied.

For example, if the equipment exhaust pressure varies from 200 Pa to 150 Pa, the amount of cooling gas flowing through the cooling gas passage 352 is decreased by the variation of the equipment exhaust pressure.

On the other hand, if the equipment exhaust pressure varies from 150 Pa to 200 Pa, the amount of cooling gas flowing through the cooling gas passage 352 is increased by the variation of the equipment exhaust pressure.

In this way, if the amount of cooling gas flowing through the cooling gas passage 352 is varied by the variation of the equipment exhaust pressure, the cooling ability of the flowing cooling gas is affected so that, for example, although cooling gas flow rate control and temperature control are performed in advance based on a temperature measured by the inner temperature sensor 324 so as to keep the center part of the wafer 12 at a predetermined set temperature (processing temperature) and the end part of the wafer 12 at a temperature lower than the processing temperature, cooling performance for cooling the outer tube 360 and the wafer 12 set in the boat 14 from the circumferences thereof is varied.

Hence, in the case where the cooling performance varies in the circumferential direction, for example, the temperature of the end part of the wafer 12 can be higher than the processing temperature, and thus the repeatability of the in-surface film thickness of the wafer 12 cannot be attained.

As explained above, in the semiconductor processing apparatus 1 relevant to the second type to which the present invention is applied, the repeatability of the film thickness of the wafer 12 is acceptable when the equipment exhaust pressure is constant; however, when the equipment exhaust pressure is not constant, the repeatability of the film thickness of the wafer 12 cannot be attained, and thus the film thickness may be non-uniform.

Therefore, in a semiconductor processing apparatus 1 (set forth hereinafter) relevant to a third type to which the present invention is applied, a peculiar idea is embodied to make the film thickness of a wafer 12 uniform although the equipment exhaust pressure is non-uniform or varied.

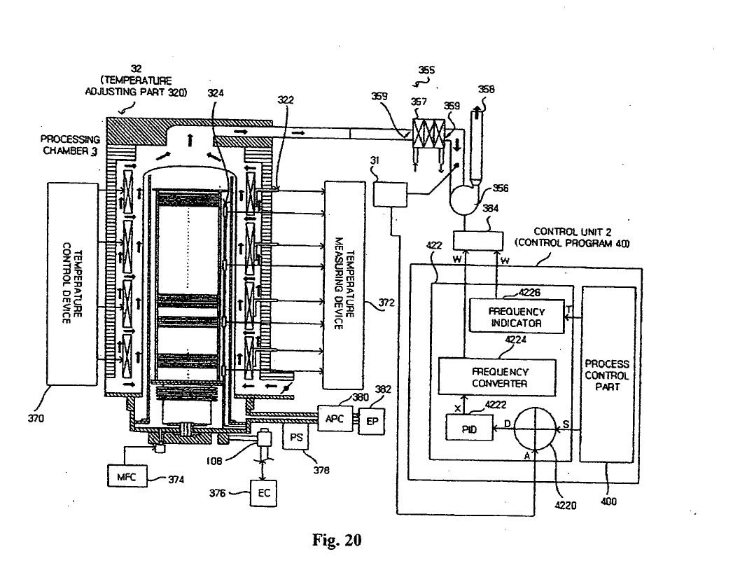

FIG. 20 illustrates the structure of the semiconductor processing apparatus 1 relevant to the third type to which the present invention is applied.

The semiconductor processing apparatus 1 relevant to the third type to which the present invention is applied has a peculiar structure for making the film thickness of a wafer 12 uniform even though the equipment exhaust pressure is non-uniform or varied, in addition to the structure of the semiconductor processing apparatus 1 described in FIG. 15 to FIG. 18 relevant to the second type to which the present invention is applied.

As shown in FIG. 20, in the semiconductor processing apparatus 1, a pressure sensor 31 is installed at a pipe connected between a cooling gas exhaust device 356 and a radiator 357 of an exhaust unit 355 so as to detect the pressure inside the pipe. Preferably, the pressure sensor 31 is installed at the pipe between the cooling gas exhaust device 356 and the radiator 357 as close as possible to the radiator 357. By installing the pressure sensor 31 close to the radiator 357, a pressure loss caused by a pipe length, a pipe passage, a pipe shape, etc. from the radiator 357 to the pressure sensor 31 can be prevented.

Like that of the above-described semiconductor processing apparatus 1 which is the base of the present invention, a control program 40 is configured by a process control part 400 (process control device), a temperature control part 410 (temperature control device), a processing gas flow rate control part 412 (processing gas flow rate control device), a driving control part 414 (driving control device), a pressure control part 416 (pressure control device), a processing gas exhaust device control part 418 (processing gas exhaust control device), a temperature measuring part 420 (temperature control device), a cooling gas flow rate control part 422 (cooling gas control device), and a temperature set value memory part 424 (temperature control device).

In FIG. 20, the process control part 400 and the cooling gas flow rate control part 422 are illustrated, and the temperature control part 410, the processing gas flow rate control part 412, the driving control part 414, the pressure control part 416, the processing gas exhaust device control part 418, the temperature measuring part 420, and the temperature set value memory part 424 are not illustrated.

Like that of the above-described semiconductor processing apparatus 1 which is the base of the present invention, the control program 40 is provided to a control unit 2 via, for example, a recording medium 240 (refer to FIG. 18) and is loaded and executed on a memory 204.

The cooling gas flow rate control part 422 is configured by a subtracter 4220, a PID calculating part 4222, a frequency converter 4224, and a frequency indicator 4226.

The subtracter 4220 receives a pressure target value (S) from the process control part 400.

Here, the pressure target value (S) is a previously calculated value for allowing the temperature of the end part of the wafer 12 to be lower than a processing temperature when the center part of the wafer 12 is at a predetermined set temperature (the processing temperature)—for example, a temperature correction value of the inner temperature sensor 324 stored in the temperature set value memory part 424, and a pressure value at the temperature correction value may be used.

In addition to the pressure target value (S), the subtracter 4220 receives a pressure value (A) measured by the pressure sensor 31, and outputs a deviation (D) calculated by subtracting the pressure value (A) from the pressure target value (S).

The deviation (D) is input to the PID calculating part 4222. The PID calculating unit 4220 calculates an adjusting value (X) by PID operation based on the input deviation (D). The calculated adjusting value (X) is input to the frequency converter 4224, and the frequency converter 4224 outputs a frequency (W) by converting the adjusting value (X).

The output frequency (W) is input to an inverter 384 to change the frequency of the cooling gas exhaust device 356.

The pressure value (A) is input to the subtracter 4220 from the pressure sensor 31 at all times or at predetermined intervals, and based on the pressure value (A), the frequency of the cooling gas exhaust device 356 is continuously controlled to maintain the deviation (D) of the pressure value (A) from the pressure target value (S) at a zero level.

As explained above, to eliminate the deviation (D) between the pressure value (A) measured by the pressure sensor 31 and the preset pressure target value (S), the frequency of the cooling gas exhaust device 356 is controlled through the inverter 384. That is, a frequency adjusted to eliminate the deviation (D) is feedback-controlled using a frequency at which the deviation (D) is zero, and the cooling gas flow rate control part 422 controls the flow rate of cooling gas based on the feedback-controlled frequency.

Instead of calculating a frequency (W) using the PID calculating part 4222, the process control part 400 may input a frequency set value (T) to the frequency indicator 4226, and the frequency indicator 4226 may input a frequency (W) to the inverter 384, in order to change the frequency of the cooling gas exhaust device 356.

Owing to the above-described control, although the equipment exhaust pressure of exhaust equipment connected to the exhaust port 358 is non-uniform or varied, it can be prevented that the thickness of a film formed on the wafer 12 becomes non-uniform due to variations of a flow rate of a cooling medium flowing through the cooling gas passage 352.

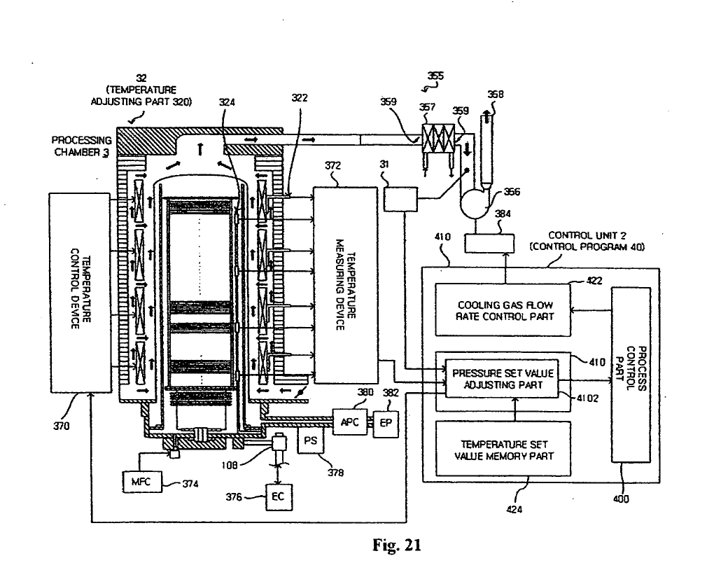

FIG. 21 illustrates the structure of a semiconductor processing apparatus 1 relevant to a fourth type to which the present invention is applied.

As explained above, in the semiconductor processing apparatus 1 relevant to the third type to which the present invention is applied, the control unit 2 controls the cooling gas exhaust device 356 based on a pressure value detected by the pressure sensor 31 used as a pressure detector. On the other hand, in the semiconductor processing apparatus 1 relevant to the fourth type to which the present invention is applied, a control unit 2 controls a cooling gas exhaust device 356 and a heater 32 used as a heating device, based on a pressure value detected by a pressure sensor 31.

A control program 40 (control device), used in the fourth type to which the present invention is applied, is configured by a process control part 400 (process control device), a temperature control part 410 (temperature control device), a processing gas flow rate control part 412 (processing gas flow rate control device), a driving control part 414 (driving control device), a pressure control part 416 (pressure control device), a processing gas exhaust device control part 418 (processing gas exhaust device control device), a temperature measuring part 420 (temperature measuring device), a cooling gas flow rate control part 422 (cooling gas flow rate control device), and a temperature set value memory part 424 (temperature set memory device).

In FIG. 21, the process control part 400, the temperature control part 410, the cooling gas flow rate control part 422, and the temperature set value memory part 424 are illustrated, and the processing gas flow rate control part 412, the driving control part 414, the pressure control part 416, the processing gas exhaust device control part 418, and the temperature measuring part 420 are not illustrated. Like that of the above-described semiconductor processing apparatus 1 relevant to the third type to which the present invention is applied, the control program 40 is provided to the control unit 2 via, for example, a recording medium 240 (refer to FIG. 18) and is loaded and executed on a memory 204.

The temperature control part 410 includes a pressure set value adjusting part 4102 (pressure set adjusting device). The pressure set value adjusting part 4102 calculates and sets a desired temperature distribution by using, for example, a film thickness-temperature distribution relationship table registered in the temperature set value memory part 424.

The pressure set value adjusting part 4102 compares a temperature measured by a temperature measuring device 372 with a temperature distribution registered in the temperature set value memory part 424 and calculates a pressure set value of an upstream position of the cooling gas exhaust device 356 for making the temperature distribution of a wafer 12 equal to the set temperature distribution. Then, the pressure set value adjusting part 4102 provides the pressure set value to the cooling gas flow rate control part 422 through the process control part 400. Instead of providing the pressure set value from the pressure set value adjusting part 4102 to the cooling gas flow rate control part 422 through the process control part 400, the pressure set value can be provided from the pressure set value adjusting part 4102 directly to the cooling gas flow rate control part 422.

The control of the cooling gas exhaust device 356 under the instructions of the pressure set value adjusting part 4102 is performed until the temperature distribution becomes equal to the set temperature distribution, while suppressing an extreme temperature variation by using, for example, a PID operation and setting a PID constant as in the first embodiment described above, so as to realize rapid and stable temperature controlling.

In addition, the temperature control part 410 including the pressure set value adjusting part 4102 controls the pressure of the upstream position of the cooling gas exhaust device 356 by providing the pressure set value to the cooling gas exhaust device 356, and at the same time, the temperature control part 410 controls the heater 32 through a temperature control device 370 based on temperatures measured by the temperature measuring device 372 and a temperature distribution set by the pressure set value adjusting part 4102.

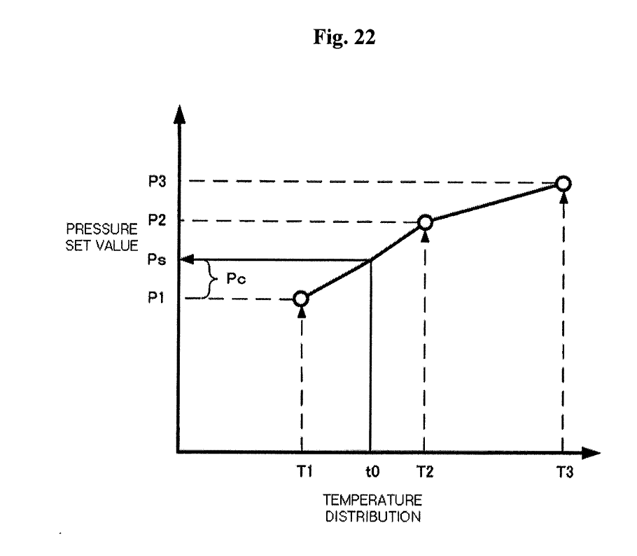

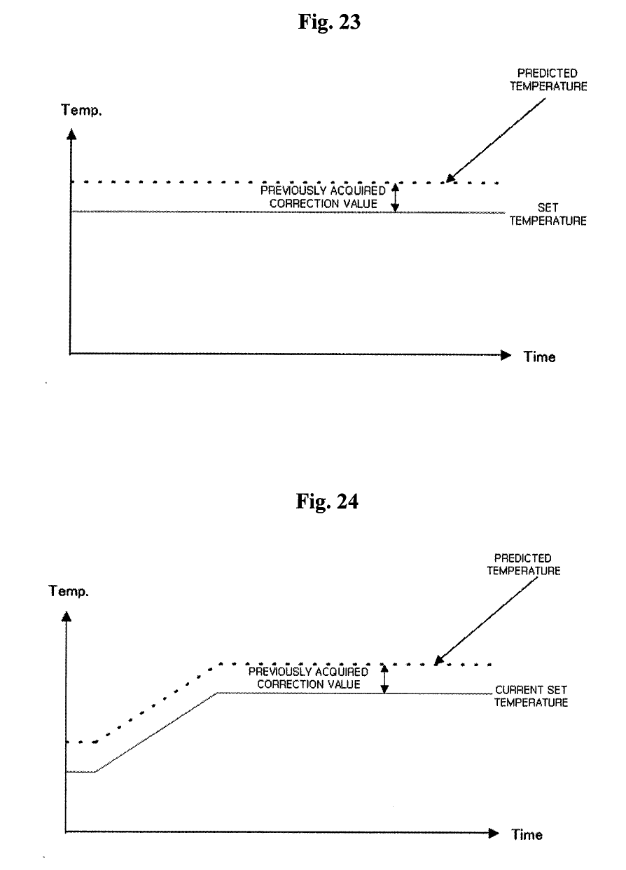

FIG. 22 is an exemplary view for explaining a calculation operation of a pressure set value by the pressure set value adjusting part 4102.

Prior to calculation, pressure values corresponding to temperature distributions of a wafer 12 are registered in, for example, the temperature set value memory part 424, and a pressure set value-temperature distribution relationship table is acquired and input. The input data may be acquired at the same time with the acquisition of a film thickness-temperature distribution relationship table.

In calculation, a pressure set value is input to the cooling gas exhaust device 356, and if there is a difference between a temperature distribution value of the wafer 12 corresponding to the input pressure set value and a previously registered temperature distribution value, a correction value is calculated for the pressure set value using the pressure set value-temperature distribution relationship table, and the calculation result is provided to the cooling gas flow rate control part 422.

For example, as shown in FIG. 22, when registered temperature distribution values are T1, T2, and T3 (T1<T2<T3), a pressure set value P1 is registered for the registered temperature distribution value T1, a pressure set value P2 is registered for the registered temperature distribution value T2, and a pressure set value P3 is registered for the registered temperature distribution value T3. If a current pressure set value is Ps and a corresponding temperature distribution value of the wafer 12 is t0, a pressure correction value Pc is calculated by Formula 2 below if the temperature distribution value t0 is in the range of Formula 1 below.

T1<t0<T2 (Formula 1)

Pc={(P2−P1)/(T2−T1)}*(t0−T1) (Formula 2)

In addition, the pressure correction value Pc is calculated by Formula 4 below when the temperature distribution value t0 is in the range of Formula 3 below; the pressure correction value Pc is calculated by Formula 6 below when the temperature distribution value t0 is in the range of Formula 5 below; and the pressure correction value Pc is calculated by Formula 8 below when the temperature distribution value t0 is in the range of Formula 7 below.

t0<T1 (Formula 3)

Pc={(P2−P1)/(T2−T1)}*(T1−t0) (Formula 4)

T3<t0 (Formula 5)

Pc={(P3−P2)/(T3−T2)}*(t0−T3) (Formula 6)

T2<t0<T3 (Formula 7)

Pc={(P3−P2)/(T3−T2)}*(t0−T2) (Formula 8)

As explained above, in the semiconductor processing apparatus 1 relevant to the fourth type to which the present invention is applied, the heater 32 as well as the cooling gas exhaust device 356 is controlled based on a pressure value measured by the pressure sensor 31. The same elements as those of the semiconductor processing apparatus 1 relevant to the third type to which the present invention is applied are denoted by the same reference numerals as those of FIG. 20, and descriptions thereof are omitted.

In the above-described second, third, and fourth types to which the present invention is applied, like the case of the first type to which the present invention is applied and in which only one second thermocouple 1064 is installed at the circumference of a wafer 12, only one inner temperature sensor 324 is installed at the circumference of a wafer 12. Therefore, like in the case of the first type to which the present invention is applied, a temperature is measured only at a part of the circumference of the wafer 12 using the inner temperature sensor 324, and thus there is a problem in that a temperature difference along the circumference of the wafer 12 is not reduced. Thus, third to fifth embodiments are provided by applying ideas of the present invention to the second, third, and fourth type.

That is, in the third embodiment of the present invention relevant to the above-described second type, a plurality of inner temperature sensors 324—for example, four inner temperature sensors 324—are installed along the circumference of a wafer 12 like the second thermocouples 1064 of the first embodiment of the present invention, and the average of outputs of equal-height temperature detecting points of the inner temperature sensors 324 is calculated, and the calculated average is used for controlling.

Furthermore, in the fourth embodiment of the present invention relevant to the above-described third type to which the present invention is applied, a plurality of inner temperature sensors 324—for example, four inner temperature sensors 324—are installed along the circumference of a wafer 12 like the second thermocouples 1064 of the first embodiment of the present invention, and the average of outputs of equal-height temperature detecting points of the inner temperature sensors 324 is calculated, and the calculated average is used for controlling.

Furthermore, in the fifth embodiment of the present invention relevant to the above-described fourth type to which the present invention is applied, a plurality of inner temperature sensors 324—for example, four inner temperature sensors 324—are installed along the circumference of a wafer 12 like the second thermocouples 1064 of the first embodiment of the present invention, and the average of outputs of equal-height temperature detecting points of the inner temperature sensors 324 is calculated, and the calculated average is used for controlling.

Furthermore, in the third to fifth embodiments of the present invention, when one of the plurality of inner temperature sensors 324 is defective, a proper control operation may not be performed if the average of outputs of the rest non-defective inner temperature sensors 324 is used for controlling instead of using the average of outputs of all the inner temperature sensors 324. Therefore, in the third to fifth embodiments of the present invention, the average value of outputs of the inner temperature sensors 324, and deviations (correction values) of the outputs of the inner temperature sensors 324 from the average value are previously acquired like in the above-described second embodiment. Therefore, when any one of the inner temperature sensors 324 is defective, a temperature, which may be detected from the defective inner temperature sensor 324 if the inner temperature sensor 324 is not defective, is predicted using the previously acquired correction value, and the predicted value is used for controlling.

Furthermore, in a sixth embodiment of the present invention, like in the above-described second embodiment, the average value of outputs of a plurality of inner temperature sensors 324-1 to 324-4, and deviations (correction values) of the outputs of the inner temperature sensors 324 are previously acquired. When one of the plurality of inner temperature sensors 324-1 to 324-4 is defective, a temperature, which may be detected from the defective inner temperature sensor 324 if the inner temperature sensor 324 is not defective, is predicted using a current set value and the previously acquired correction value, and the predicted temperature is used for calculating the average temperature of the defective inner temperature sensor 324 and the non-defective inner temperature sensors 324 and performing a control operation using the calculated average temperature, so that repeatability can be ensured as if no the inner temperature sensor 324 is defective. Here, the current set value is a set value varying with time according to a set ramp rate as shown in FIG. 24. Since the current set value varies according to the ramp rate, this method may be effective in the case of a transitional temperature period.

The sixth embodiment will be explained with reference to a specific example. For instance, when there are provided a plurality of inner temperature sensors 324 (324-1, 324-2, 324-3, and 324-4) and an in-furnace set temperature is 600° C., it is assumed that outputs of the inner temperature sensors 324 are as follows. The set temperature is 600° C.; the output of the inner temperature sensor 324-1 is 601° C.; the output of the inner temperature sensor 324-2 is 598° C.; the output of the inner temperature sensor 324-3 is 599° C.; the output of the inner temperature sensor 324-4 is 602° C. Here, correction values for the inner temperature sensors 324-1 to 324-4 are as follows. Correction value for inner temperature sensor 324-1=output value of inner temperature sensor 324-1−average value=601° C.-600° C.=+1.0° C. Here, the average value is the average value of the inner temperature sensors 324-1 to 324-4 and becomes equal to the set value of 600° C. because temperature controlling is performed to make the average value equal to the set value. Similarly, correction value for inner temperature sensor 324-2=output value of inner temperature sensor 324-2−average value=598° C.-600° C.=−2.0° C. Correction value for inner temperature sensor 324-3=output value of inner temperature sensor 324-3−average value=599° C.-600° C.=−1.0° C. Correction value for inner temperature sensor 324-4=output value of inner temperature sensor 324-4−average value=602° C.-600° C.=+2.0° C.

Here, if the inner temperature sensor 324-1 malfunctions during a transitional temperature period (prior to a stable temperature period) where the set value varies from 400° C. to 600° C. at a temperature raising rate of 10° C./min, a temperature value of the inner temperature sensor 324-1 after X minutes can be predicted as follows. Since temperature is raised from 400° C. to 600° C. at a temperature raising rate of 10° C./min, a current set value after X minutes as follows: current set value=400° C.+Xmin*10° C./min, where 0<=X<=20.

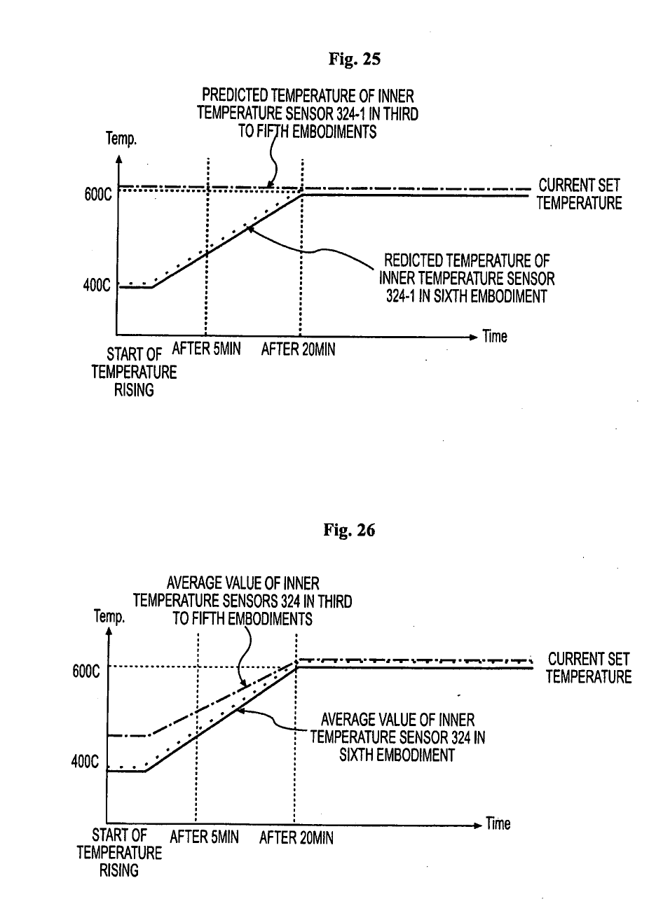

The temperature value of the inner temperature sensor 324-1 is predicted as follows. Predicted value of inner temperature sensor 324-1=current set value +correction value of inner temperature sensor 324-1=400° C.+Xmin*10° C./min+1.0° C., where 0<=X<=20. During the transitional temperature period, as shown in FIG. 25, the predicted value of the inner temperature sensor 324-1 varies with time according to the temperature raising rate like the set value. For example, if output values of inner temperature sensors 324-2, 324-3, and 324-4 are 448.5° C., 449.5° C., and 452.0° C., respectively, after 5 minutes from the start of temperature raising, the average value of the inner temperature sensors 324 is calculated as follows: since predicted value of inner temperature sensor 324-1=current set value+correction value of inner temperature sensor 324-1=400° C.+5 min*10° C./min+10° C.=451.0° C., the average value of inner temperature sensors (after 5 minutes from the temperature raising)=(predicted value of inner temperature sensor 324-1+output value of inner temperature sensor 324-2+output value of inner temperature sensor 324-3+output value of inner temperature sensor 324-4)/4=(451.0° C.+448.5° C.+449.5° C.+452.0° C.)/4=450.25° C.

Here, if the inner temperature sensor 324-1 is not defective and it is assumed that the output of the inner temperature sensor 324-1 is equal to the output of the inner temperature sensor 324-4 because it is thought, from the correction values of the respectively inner temperature sensors, that the inner temperature sensor 324-1 outputs a value close to the output of the inner temperature sensor 324-4, the average values of the inner temperature sensors 324=(452.0° C.+448.5° C.+449.5° C.+452.0° C.)/4=450.5° C.

In the third to fifth embodiments, the temperature value of the 324-1 is predicted as follows. Predicted value of inner temperature sensor 324-1=set value+correction value of inner temperature sensor 324-1=600° C.+1.0° C.=601.0° C., and in this case, the average value of the inner temperature sensors 324=(predicted value of inner temperature sensor 324-1+output of inner temperature sensor 324-2+output of inner temperature sensor 324-3+output of inner temperature sensor 324-4)=(601.0° C.+448.5° C.+449.5° C.+452.0° C.)/4=487.7° C.

Here, in the third to fifth embodiment of the present invention, the average value of the inner temperature sensors 324 is calculated using a predicted value of a stable temperature period although the period is a transitional temperature period. Therefore, in the transitional temperature period, as shown in FIG. 26, the calculated average value is high as compared with the case where the inner temperature sensor 324-1 is not-defective.

In the sixth embodiment of the present invention, the average value of the inner temperature sensors 324 calculated using the predicted value of the inner temperature sensor 324-1 is not deviated largely from the average when the inner temperature sensor 324-1 is not defective, and repeatability is ensured. Therefore, problems in the transitional temperature period can be solved according to the sixth embodiment of the present invention.

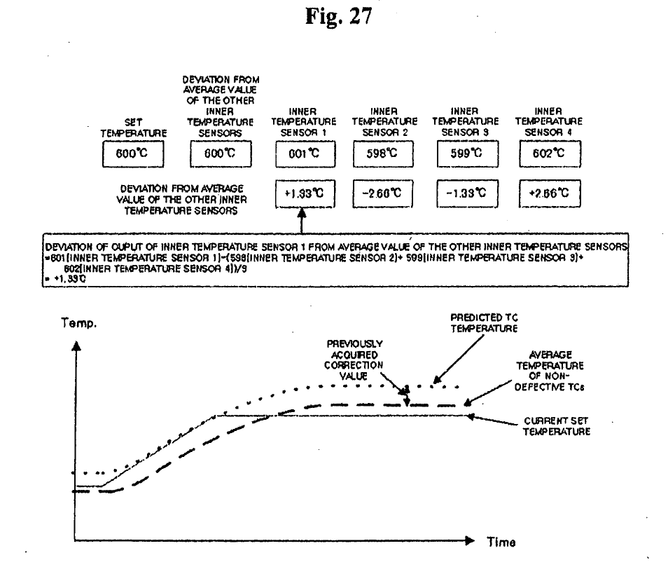

In a seventh embodiment of the present invention, as shown in FIG. 27, outputs of a plurality of inner temperature sensors 324 are used in a manner such that a difference (correction value) between an output of one of the inner temperature sensors 324 and the average of outputs of the others is acquired. When one of the inner temperature sensors 324 is defective, a temperature, which may be detected from the defective inner temperature sensor 324 if the inner temperature sensor 324 is not defective, is predicted using the previously acquired average value of the non-defective inner temperature sensors 324 and the correction value of the defective value, and the average value of all the inner temperature sensors 324 is calculated using the predicted temperature, for the purpose of temperature controlling, so that a temperature control operation can be effectively performed according to temperature variations caused by variations of processing conditions such as pressure and gas flow rate in addition to temperature variation in a transitional temperature period.

An explanation will be given on an exemplary case where a plurality of inner temperature sensors 324: 324-1, 324-2, 324-3, and 324-4 are provided, an in-furnace temperature is set to 600° C., and outputs of the inner temperature sensors 324 are as follows.

Set temperature: 600° C., output of inner temperature sensor 324-1: 601° C., output of inner temperature sensor 324-2: 598° C., output of inner temperature sensor 324-3: 599° C., and output of inner temperature sensor 324-4: 602° C. Here, correction values for the inner temperature sensors 324-1 to 324-4 are as follows.

Correction value for inner temperature sensor 324-1=output value of inner temperature sensor 324-1−(output value of inner temperature sensor 324-2+output value of inner temperature sensor 324-3+output value of inner temperature sensor 324-4)/3=601° C.−599.7° C.=+1.3° C.

In the same way, correction value for inner temperature sensor 324-2=output value of inner temperature sensor 324-2−(output value of inner temperature sensor 324-1+output value of inner temperature sensor 324-3+output value of inner temperature sensor 324-4)/3=598° C.-600.7° C.=−2.7° C.

In the same way, correction value for inner temperature sensor 324-3=output value of inner temperature sensor 324-3−(output value of inner temperature sensor 324-1+output value of inner temperature sensor 324-2+output value of inner temperature sensor 324-4)/3=599° C.-600.3° C.=−1.3° C.

In the same way, correction value for inner temperature sensor 324-4=output value of inner temperature sensor 324-4−(output value of inner temperature sensor 324-1+output value of inner temperature sensor 324-2+output value of inner temperature sensor 324-3)/3=602° C.-599.3° C.=+2.7° C.

If the inner temperature sensor 324-1 malfunctions, a temperature value of the inner temperature sensor 324-1 is predicted using the following equation. Predicted value of inner temperature sensor 324-1=(output value of inner temperature sensor 324-2+output value of inner temperature sensor 324-3+output value of inner temperature sensor 324-4)/3+correction value of inner temperature sensor 324-1.

For example, in the case where inner temperature sensor 324-1: defective, output value of inner temperature sensor 324-2: 448.5° C., output value of inner temperature sensor 324-3: 449.5° C., and output value of inner temperature sensor 324-4: 452.0° C. after 5 minutes from the start of temperature raising, a temperature value of the inner temperature sensor 324-1 is predicted as follows: predicted value of inner temperature sensor 324-1=(448.5° C.+449.5° C.+452.0° C.)/3+1.3° C.=451.3° C., and the average value of the inner temperature sensors 324 is calculated using the predicted value of the inner temperature sensor 324-1 as follows: average value of inner temperature sensors 324=(predicted value of inner temperature sensor 324-1+output value of inner temperature sensor 324-2+output value of inner temperature sensor 324-3+output value of inner temperature sensor 324-4)/4=(451.3° C.+448.5° C.+449.5° C.+452.0° C.)/4=450.32° C.

In the third to fifth embodiments of the present invention, a temperature value of the inner temperature sensor 324-1 is predicted using the following equation. Predicted value of inner temperature sensor 324-1=set value +correction value of inner temperature sensor 324-1=600° C.+1.0° C.=601.0° C. In this case, the average value of the inner temperature sensors 324 is calculated as follows: average value of inner temperature sensors 324=(predicted value of inner temperature sensor 324-1+output value of inner temperature sensor 324-2+output value of inner temperature sensor 324-3+output value of inner temperature sensor 324-4)/4=(601.0° C.+448.5° C.+449.5° C.+452.0° C.)=487.75° C.

In the third to fifth embodiments of the present invention, the average value of the inner temperature sensors 324 is predicted using a temperature value of the inner temperature sensor 324-1 predicted by a method adapted for a stable temperature period even when the period is a transitional temperature period. Therefore, in the transitional temperature period, as shown in FIG. 26, the calculated average value is high as compared with the case where the inner temperature sensor 324-1 is not-defective. However, the average value of the inner temperature sensors 324 predicted using a predicted value of the inner temperature sensor 324-1 in accordance with the seventh embodiment of the present invention is not deviated largely from the average when the inner temperature sensor 324-1 is not defective, and thus repeatability is ensured. Therefore, problems in the transitional temperature period can be solved according to the current embodiment.

In addition, for example, due to variations of processing conditions such as gas flow rate and pressure, temperature distribution can be varied largely as compared with the time when correction values of the inner temperature sensors 324 are acquired. In this case, for example, if output values of the inner temperature sensors 324 after 5 minutes from the start of temperature raising are measured as follows: inner temperature sensor 324-1 is detective, output value of inner temperature sensor 324-2=420.5° C., output value of inner temperature sensor 324-3=439.5° C., and output value of inner temperature sensor 324-4=410.0° C., a temperature value of the inner temperature sensor 324-1 is predicted according to the current embodiment as follows: predicted value of inner temperature sensor 324-1=(output value of inner temperature sensor 324-2+output value of inner temperature sensor 324-3+output value of inner temperature sensor 324-4)/3+correction value of inner temperature sensor 324-1=(420.5° C.+439.5° C.+410.0° C.)/3+1.3° C.=424.6° C.

In this case, the average value of the inner temperature sensors 324 is calculated as follows: average value of inner temperature sensors 324=(predicted value of inner temperature sensor 324-1+output value of inner temperature sensor 324-2+output value of inner temperature sensor 324-3+output value of inner temperature sensor 324-4)/4=(424.6° C.+420.5° C.+439.5° C.+410.0° C.)/4=423.65° C.

In the third to fifth embodiment of the present invention, a temperature value of the inner temperature sensor 324-1 is predicted as follows: predicted value of inner temperature sensor 324-1=current set value +correction value of inner temperature sensor 324=400° C.+5 min*10° C./min+1.0° C.=451.0° C.

In this case, the average value of the inner temperature sensors 324 may be calculated as follows: average value of inner temperature sensors 324=(predicted value of inner temperature sensor 324-1+output value of inner temperature sensor 324-2+output value of inner temperature sensor 324-3+output value of inner temperature sensor 324-4)/4=(451.0° C.+420.5° C.+439.5° C.+410.0° C.)/4=430.25° C.

Since it is considered, from the correction values of the inner temperature sensors 324, that the output of the inner temperature sensor 324-1 is closest the output of the inner temperature sensor 324-4 in the case where the inner temperature sensor 324 is not defective, it can be assumed that the output of the inner temperature sensor 324-1=the output of the inner temperature sensor 324-4. In this case, the average value of the inner temperature sensors 324 is calculated as follows: average value of inner temperature sensors 324 (if not defective)=(410.0° C.+420.5° C.+439.5° C.+410.0° C.)/4=420.0° C.

In the sixth embodiment of the present invention, the average value of the inner temperature sensors 324 is calculated using a temperature value of the inner temperature sensor 324-1 predicted from the condition where the correction value of the inner temperature sensor 324-1 is acquired. Therefore, when the inner temperature is varied due to external disturbance, the predicted average value of the inner temperature sensors 324 differs from the actual average value of the inner temperature sensors 324.

In the seventh embodiment of the present invention, although correction values are previously acquired, and a temperature of a defective inner temperature sensor is predicted using the average of current outputs of the other non-defective inner temperature sensors, so that problems resulted from condition variations caused by external disturbance can be solved.

In the above, it is preferable that the inner temperature sensor 324 be installed at a height of a product wafer region rather than a dummy wafer region in order to detect a temperature at the edge part of the product wafer. Here, the product wafer means a wafer on which semiconductor devices such as ICs are actually formed, and dummy wafers are wafers disposed at both end of a boat with the product wafer in-between so as to prevent dissipation of heat from the product wafer region and protect the product wafer from fine particles or contaminants flowing from the top and bottom sides of a reaction chamber.

Furthermore, for example, it may be preferable that the seventh embodiment be used in a transitional temperature period and the third to fifth embodiments be used in a stable temperature period. Although switching between the seventh embodiment and the third to fifth embodiments can be performed at the end of a temperature raising period (after 20 minutes in the case of raising from 400° C. to 600° C. at 10° C./min), the switching is performed after the temperature raising period is completed and a temperature deviation between the average value of inner temperature sensors and a set value is reduced within a predetermined range.

As explained above, by performing a correction operation in a transitional temperature period in accordance with the seventh embodiment, repeatability in the transitional temperature period and proper handling of external disturbance can be ensured. In addition, by performing a correction operation in a stable temperature period in accordance with the third to fifth embodiments, influence of external disturbance can be eliminated, and normal state repeatability can be ensured.

In the seventh embodiment, by choosing one of the inner temperature sensors 324-1, 324-2, 324-3, and 324-4 as a reference (for example, the inner temperature sensor 324-1) and keeping a deviation of a temperature value of the inner temperature sensor 324-1 from the average value of the other inner temperature sensors 324-2, 324-3, and 324-4 within a predetermined range, a temperature deviation along the circumference of a wafer can be reduced within a predetermined range.

In the related art, the average value of the inner temperature sensors 324-1, 324-2, 324-3, and 324-4 is controlled using a set value; however, in the seventh embodiment, the reference inner temperature sensor 324-1 is controlled using a set value. While monitoring a temperature deviation from the average value of the other inner temperature sensors 324-2, 324-3, and 324-4, exhaust pressure is controlled if the temperature deviation becomes out of a predetermined range sot that a temperature difference along the circumference of a wafer can be controlled within a predetermined range.

According to the present invention, there are provided a semiconductor manufacturing apparatus and a substrate processing method that can reduce a temperature difference along the circumference of a substrate and continue substrate processing even when a temperature sensor malfunctions.

As described above, the present invention can be applied as a semiconductor manufacturing apparatus and a substrate processing method.

(Supplementary Note)

The present invention also includes the following embodiments.

According to an embodiment of the present invention, there is provided a semiconductor manufacturing apparatus including: a processing chamber configured to process a substrate; a heating device configured to heat the processing chamber; a cooling gas passage between the processing chamber and the heating device; a pressure detector configured to detect a pressure value inside a cooling gas exhaust passage communicating with a downstream side of the cooling gas passage when a cooling gas is allowed to flow through the cooling gas passage by a cooling device; and a control unit configured to control the heating device and the cooling device for processing the substrate, wherein the control unit previously acquires a measured value of a first temperature detecting unit that detects a state of a center part of the substrate, and an average value of measured values of a plurality of second temperature detecting units that are located at the same height and configured to detect states of a peripheral part of the substrate, and the control unit controls the heating device and the cooling device based on the acquired values.

According to another embodiment of the present invention, there is provided a semiconductor manufacturing apparatus including: a processing chamber configured to process a substrate; a heating device configured to heat the processing chamber; a cooling gas passage between the processing chamber and the heating device; a pressure detector configured to measure a pressure value at the cooling gas passage; a temperature detecting unit configured to detect a temperature of the substrate; and a control unit configured to control the heating device and a cooling device for processing the substrate, wherein the control unit previously acquires a measured value of a first temperature detecting unit that detect a temperature of a center part of the substrate, and an average value of measured values of a plurality of detecting points arranged along a circumference of the substrate and provided in a second temperature detecting unit that detects temperatures of a peripheral part of the substrate, and the control unit controls the heating device and the cooling device based on the acquired values.

According to another embodiment of the present invention, there is provided a substrate processing method including: a step of processing the substrate in which when a cooling gas is allowed to flow through a cooling gas passage using a cooling device while heating a processing chamber using a heating device, the heating device and the cooling device are controlled by a control unit based on a pressure value at the cooling gas passage; and a step of previously acquiring an average value of measured values of a plurality of second detecting units that are located at the same height and configured to detect previously measured states of a peripheral part of the substrate, and a measured value of a first detecting unit that detects a state of a center part of the substrate, calculating a deviation between the average value of the second detecting units and the measured value of the first detecting unit, comparing a deviation that is previously stored before the step of processing the substrate with a deviation calculated during the step of processing the substrate, calculating a pressure correction value for the cooling gas passage based on the calculated deviation if the two deviations are different, and correcting the pressure value using the pressure correction value.

According to another embodiment of the present invention, there is provided a substrate processing method including: a step of previously acquiring a measured value of a first temperature detecting unit that detects a temperature of a center part of a substrate, and an average value of measured values of a plurality of detecting points arranged along a circumference of the substrate and provided in a second temperature detecting unit that detects temperatures of a peripheral part of the substrate, calculating a pressure correction value for a pressure value of a cooling gas passage formed between a processing chamber configured to process the substrate and a heating device based on the acquired values, and correcting the pressure value using the pressure correction value; and a step of supplying a cooling gas through the cooling gas passage using a cooling device, while heating the processing chamber using the heating device, and controlling the heating device and the cooling device using a control unit based on the corrected pressure value, so as to process the substrate.

According to another embodiment of the present invention, there is provided a semiconductor manufacturing apparatus including: a processing chamber configured to process a substrate; a heating device configured to heat the processing chamber; a cooling gas passage between the processing chamber and the heating device; a pressure detector configured to detect a pressure value inside a cooling gas exhaust passage communicating with a downstream side of the cooling gas passage when a cooling gas is allowed to flow through the cooling gas passage by a cooling device; and a control unit configured to control the heating device and the cooling device for processing the substrate, wherein the control unit is used for previously acquiring a measured value of a first temperature detecting unit that detects a state of a center part of the substrate, and an average value of measured values of a plurality of second temperature detecting units that are located at the same height and configured to detect states of a peripheral part of the substrate, calculating a deviation between the measured value of the first detecting unit and the average value of the second detecting units, comparing a deviation that is previously stored before a substrate processing process with a deviation calculated during the substrate processing process, calculating a pressure correction value for the cooling gas passage based on the calculated deviation if the two deviations are different, and correcting the pressure value using the pressure correction value.

Preferably, the second detecting units may be a plurality of temperature detecting units disposed at the vicinity of the peripheral part of a substrate, and the first temperature detecting unit may be disposed between substrate holders that support substrates, above the substrate holders, or under substrate holders.

In addition, preferably, deviations of the measured values of the second temperature detecting units from a set value may be previously calculated and stored, and when at least one of the second temperature detecting units becomes defective, the average value may be calculated based on the previously calculated deviation of the defective second temperature detecting unit, and temperature controlling may be performed using the calculated average value.

According to another embodiment of the present invention, there is provided a semiconductor manufacturing apparatus including a control system configured to control film uniformity on a substrate, wherein the control system performs a control operation including: a step of processing the substrate in which when a cooling gas is allowed to flow through a cooling gas passage using a cooling device while heating a processing chamber using a heating device, the heating device and the cooling device are controlled by a control unit based on a pressure value at the cooling gas passage; and a step of previously acquiring a measured value of a first detecting unit that detects a state of a center part of the substrate, and an average value of measured values of a plurality of second detecting units that are located at the same height and configured to detect previously measured states of a peripheral part of the substrate, calculating a deviation between the measured value of the first detecting unit and the average value of the second detecting units, comparing a deviation that is previously stored before the step of processing the substrate with a deviation calculated during the step of processing the substrate, calculating a pressure correction value for the cooling gas passage based on the calculated deviation if the two deviations are different, and correcting the pressure value using the pressure correction value.

Preferably, the control system may previously calculate and store deviations of the measured values of the second temperature detecting units from a set value, and when at least one of the second temperature detecting units becomes defective, the control system may calculate the average value based on the previously calculated deviation of the defective second temperature detecting unit and control temperature using the calculated average value.

According to another embodiment of the present invention, there is provided a heat treatment apparatus including a plurality of thermocouples configured to detect temperatures at the vicinity of a wafer and installed along a circumference of the wafer, so as to reduce a temperature difference along the circumference of the wafer.

Preferably, there may further be provided a mount part in which a programmed method for regulating an in-surface temperature distribution of a wafer is stored in a computer.

According to another embodiment of the present invention, there is provided a heat treatment apparatus including a control unit (control device), wherein the control unit detects a temperature at the vicinity of a wafer and acquires correction values of a plurality of thermocouples installed at the vicinity of the wafer so that when one of the thermocouples becomes defective, the control unit predicts an output of the defective thermocouple based on the acquired correction values of the thermocouples and performs a control operation based on the prediction.

Preferably, the control unit (control device) may include a mount part in which a programmed method for predicting an output of a defective one of the plurality of thermocouples is stored in a computer.

What is claimed is:

1. A semiconductor manufacturing apparatus comprising:
a processing chamber configured to process a substrate;
a heating device configured to heat the processing chamber;
a cooling gas passage between the processing chamber and the heating device;
a pressure detector configured to measure a pressure value at the cooling gas passage;
a temperature detecting unit configured to detect a temperature of the substrate; and
a control unit configured to control the heating device and a cooling device for processing the substrate,
wherein the control unit previously acquires a measured value of a first temperature detecting unit that detects a temperature of a center part of the substrate, and an average value of measured values of a plurality of detecting points arranged along a circumference of the substrate and provided in a second temperature detecting unit that detects temperatures of a peripheral part of the substrate, and the control unit controls the heating device and the cooling device based on the acquired values.

2. A substrate processing method comprising:
a step of previously acquiring a measured value of a first temperature detecting unit that detects a temperature of a center part of a substrate, and an average value of measured values of a plurality of detecting points arranged along a circumference of the substrate and provided in a second temperature detecting unit that detects temperatures of a peripheral part of the substrate, calculating a pressure correction value for a pressure value of a cooling gas passage between a processing chamber configured to process the substrate and a heating device based on the acquired values, and correcting the pressure value using the pressure correction value; and
a step of supplying a cooling gas through the cooling gas passage using a cooling device, while heating the processing chamber using the heating device, and controlling the heating device and the cooling device using a control unit based on the corrected pressure value, so as to process the substrate.

3. A semiconductor manufacturing apparatus comprising:
a processing chamber configured to process a substrate;
a heating device configured to heat the processing chamber;
a cooling gas passage between the processing chamber and the heating device;
a pressure detector configured to measure a pressure value at the cooling gas passage;
a plurality of temperature detecting units configured to detect temperatures inside the processing chamber; and
a control unit configured to control the heating device and a cooling device for processing the substrate,
wherein the control unit calculates an average value of measured values of the temperature detecting units that detect temperatures inside the processing chamber, and deviations of the measured values of the temperature detecting units from the average value of the measured values, and
the control unit controls at least one of the heating device and the cooling device based on the calculated deviations.

4. A substrate processing method comprising:
a step of previously acquiring an average value of measured values of a plurality of detecting points arranged along a circumference of a substrate and provided in a temperature detecting unit that detects temperatures of a peripheral part of the substrate, and a measured value of each of the detecting points, and calculating a pressure correction value for a pressure value of a cooling gas passage between a processing chamber configured to process the substrate and a heating device based on the acquired average value of the measured values of the detecting points and the measured value of each of the detecting points, so as to correct the pressure value using the pressure correction value; and
a step of supplying a cooling gas through the cooling gas passage using a cooling device, while heating the processing chamber using the heating device, and controlling at least one of the heating device and the cooling device using a control unit based on the corrected pressure value, so as to process the substrate.

5. A semiconductor manufacturing apparatus comprising:
a processing chamber configured to process a substrate;
a heating device configured to heat the processing chamber;
a cooling gas passage between the processing chamber and the heating device;
a pressure detector configured to measure a pressure value at the cooling gas passage;
a plurality of temperature detecting units configured to detect temperatures inside the processing chamber; and
a control unit configured to control the heating device and a cooling device for processing the substrate,
wherein the control unit calculates a deviation of a measured value of one of the temperature detecting units from an average value of measured values of the other temperature detecting units, and
the control unit controls at least one of the heating device and the cooling device based on the calculated deviation.

6. A substrate processing method comprising:
a step of previously acquiring a measured value of one of a plurality of detecting points arranged along a circumference of a substrate and provided in a temperature detecting unit that detects temperatures of a peripheral part of the substrate, and an average value of measured values of the other detecting points, and
calculating a pressure correction value for a pressure value of a cooling gas passage between a processing chamber configured to process the substrate and a heating device based on the acquired average value of the measured values of the other detecting points and the measured value of one of the detecting points, so as to correct the pressure value using the pressure correction value; and
a step of supplying a cooling gas through the cooling gas passage using a cooling device, while heating the processing chamber using the heating device, and controlling at least one of the heating device and the cooling device using a control unit based on the corrected pressure value, so as to process the substrate.
